(19) United States
(12) Patent Application Publication
(10) Pub. No.: US 2026/0288877 A1
(43) Pub. Date: Sep. 24, 2026

(54) SEMANTIC PROGRESSION LAYER FOR GRAPH-STRUCTURED DATA

(71) Applicant: Sam Malayeksefat, Toronto (CA)

(72) Inventor: Sam Malayeksefat, Toronto (CA)

(21) Appl. No.: 19/693,574

(22) Filed: Jun. 1, 2026

Related U.S. Application Data
(63) Continuation of application No. 19/457,206, filed on Jan. 23, 2026.

(51) Int. Cl. G06F 16/904; G06F 16/901; G06F 16/903

(52) U.S. Cl. CPC G06F 16/904; G06F 16/9024; G06F 16/90335

(57) ABSTRACT

A computer-implemented semantic progression layer maintains per-user progression state over a base graph of nodes and typed edges including prerequisite edges. For a user, signals including familiarity and optionally mastery, recency, uncertainty, and goal alignment are computed and superposed onto the base graph to form a per-user overlay. From the overlay, the system derives progression-related constructs including predicate-defined region memberships and/or compact representations usable by downstream components. Region memberships may include a forward region and a backward-looking/skipped region and optionally a lateral/adjacent region, with operation in single-region, two-region, or three-or-more-region modes. Membership is determined by predicate tests under traversal constraints rather than by visualization geometry. In some implementations, constructs are stored as per-user bitsets keyed by node identifiers and are incrementally maintained via localized delta updates in response to user events without full-graph recomputation. Outputs include recommendations, structured guidance, navigation cues, visualizations, assessments, and scheduling.

### FIELD OF THE INVENTION

The present invention relates generally to data modelling and graph-structured representations, and more particularly to computer-implemented systems and methods for computing, maintaining, and serving a per-user semantic progression layer over graph-structured data, including progression-related constructs and outputs such as recommendations, structured guidance, navigation cues, schedules, or visualizations.

### BACKGROUND OF THE INVENTION

Existing systems that utilize graph-structured data often surface items primarily through direct correlations, proximity, or local similarity within the graph. These systems typically lack mechanisms for computing and/or maintaining an explicit per-user progression layer that models a user's evolving familiarity, progression, or mastery across multi-level structures. Even when contextual or multi-source data is incorporated, conventional approaches generally emphasize retrieving or ranking locally related items rather than modelling a user's position, gaps, eligibility, or potential paths through a broader semantic structure.

By contrast, the present invention models user state relative to a graph-structured representation of topics, skills, or content and derives progression-related constructs from that state, including region memberships and other progression-layer representations. Such constructs may reflect, for example, what a user may be prepared to advance toward, what foundational material may be incomplete, or what adjacent areas may broaden understanding. The semantic progression layer may be consumed by one or more downstream components to generate progression-related outputs, including recommendations, ranked content lists, guided navigation, visualizations, or structured guidance.

### SUMMARY OF THE INVENTION

In some embodiments, the present disclosure provides a computer-implemented semantic progression layer implemented over a base graph data structure storing nodes and typed edges. The system computes per-user signals (e.g., familiarity, mastery, relevance, recency, uncertainty, and/or goal alignment), superposes such signals onto the base graph to form a per-user overlay, and derives one or more progression-related constructs relative to one or more selected dimensions of interest. In certain embodiments, the progression-related constructs comprise predicate-defined region memberships computed for a user, including at least a forward region and a backward-looking region (also termed skipped), and optionally a lateral or adjacent region. The system may be configured to compute and serve exactly one region (e.g., forward-only or backward-only), exactly two regions (e.g., forward and backward), or three or more regions (e.g., forward, backward/skipped, and lateral/adjacent), and the operating mode may vary per request, session, domain, or downstream task objective. Nodes that do not satisfy the evaluated predicate(s) for the selected mode may be treated as unassigned (or assigned a neutral/none class) and may be omitted from a rendered view or displayed using neutral styling. Region membership is determined by predicate-based tests and configured traversal constraints (e.g., monotonicity on the selected dimension of interest, edge-type constraints, hop limits, or budgets) and is not determined by screen position, a drawn boundary, or any particular visualization layout; any apparent partitioning in a depiction is an illustrative consequence of applying the predicates and/or omitting unassigned nodes rather than a requirement to draw a geometric separation. In some implementations, when multiple regions are maintained, the regions are stored as pairwise disjoint sets to support deterministic presentation, explanation, and auditability.

In other embodiments, the progression-related constructs comprise candidate sets, ordered sequences, eligibility sets, continuous scores, unified ranking representations, frontier sets, diagnostic candidate sets, or other compact per-user representations, and region membership may be derived as a configurable view rather than as a required output. In still other embodiments, prerequisite constraints are incorporated as graph constraints and user state is represented by per-node scores together with eligibility or gating conditions such that progression-related outputs are generated subject to the eligibility or gating conditions. In yet other embodiments, the semantic progression layer is represented as a continuous curriculum field or potential function over the graph and progression-related outputs are generated based on the field and constrained graph neighborhoods. In further embodiments, a selected dimension of interest comprises a plurality of ordered dimensions and the system derives multi-dimensional progression constructs including frontier sets or non-dominated candidate sets keyed by stable node identifiers. In certain embodiments, the system supports diagnostic or exploration policies that select items based on uncertainty reduction and/or exploration-exploitation tradeoffs, optionally subject to prerequisite gating. One or more downstream components may consume the progression-related constructs to generate adaptive outputs including recommendations, ranked content lists, structured guidance, visualizations, navigation flows, schedules, or other progress-oriented responses.

In some embodiments, the user input may include, for example, personal preferences, goals, constraints, and contextual information.

In some embodiments, the base knowledge graph is populated from one or more content sources and/or curated corpora. By way of non-limiting example, sources may include documentation sets, Q&A repositories, textbooks, tutorials, course catalogs, code repositories, research libraries, or other digital content sources accessible via one or more ingestion interfaces. The particular ingestion mechanism (e.g., scheduled import, API retrieval, licensed corpus loading, or other acquisition) is not limiting.

In some embodiments, user-specific signals used to compute the per-user overlay may be derived from user interactions with the digital platform and/or from connected services authorized by the user, such as learning platforms, content platforms, or productivity tools. Such signals may include, for example, views, completions, dwell time, assessments, explicit feedback, saved items, and/or declared goals or preferences. The system may process such signals in aggregated, de-identified, or privacy-preserving forms consistent with applicable policies; the particular privacy controls are implementation-dependent and not limiting.

In some embodiments, the semantic progression layer is refreshed upon one or more trigger events, including user login, content interaction, assessment outcome, goal changes, and/or periodic background updates. Refresh may include recomputing (or incrementally maintaining) one or more progression-related constructs (e.g., region membership, eligibility sets, frontier sets, diagnostic sets, continuous scores, or ranked candidate sets) for downstream consumption.

In some embodiments, the semantic progression layer improves operation of the underlying computer system by addressing a technical scaling problem: maintaining per-user progression constructs over a large graph with low latency, without repeatedly performing full-graph traversals and per-node recomputation in response to user events. In certain implementations, one or more progression-related constructs (including region membership and/or eligibility, frontier, or diagnostic sets) are persisted as compact, word-addressable bitsets keyed by stable node identifiers. When a user event occurs (e.g., content consumption, completion, assessment outcome, acceptance of a surfaced item, or other interaction), the system identifies a limited set of affected node identifiers, computes a bounded local neighborhood under configured traversal constraints, recomputes membership only for that neighborhood, and applies delta updates that set and clear only the corresponding bit positions. In implementations maintaining multiple region bitsets, the system may enforce a deterministic assignment rule (e.g., a configured precedence) so that a node identifier is assigned to at most one stored region to support stable presentation, explanation, and auditability. This localized delta maintenance reduces processor cycles, memory bandwidth consumption, and random memory accesses relative to full recomputation across all nodes, thereby enabling low-latency serving of progression constructs and downstream outputs at graph sizes for which naive recomputation is impractical.

In another aspect, the present disclosure relates to a system associated with a digital platform, wherein the system may include a memory to store instructions and a processor in communication with the memory. The processor may be configured to execute the instructions to initialize a base graph data structure prior to any user input, populate the graph with data from a plurality of sources, receive a user input from a user device associated with the user, collect data from various sources corresponding to the user, generate a superposed graph of paths for consumed or familiar content, and compute one or more progression-related regions and related progression-layer constructs for the user—including at least a forward and a backward/skipped region; optionally lateral or unexplored areas in relation to the user's superposed paths. In some embodiments, these regions and/or other progression-layer constructs are consumed by one or more downstream components to generate progression-related outputs, including recommendations or guidance.

In another aspect, the present disclosure relates to a non-transitory computer-readable storage medium comprising instructions executable by a processor, the instructions to cause the processor to carry out any of the methods disclosed herein.

These and other objects, features, and advantages of the present disclosure-such as providing a structured, goal-oriented semantic progression layer that can produce and/or provide progression-layer constructs for use by downstream components to generate adaptive outputs including recommendations, structured guidance, ranked lists, or guided navigation-will become more readily apparent from the attached drawings and from the detailed description of certain illustrative embodiments, which follow.

### BRIEF DESCRIPTION OF THE DRAWINGS

The accompanying drawings, which are incorporated herein and constitute a part of the present disclosure, illustrate exemplary embodiments of the disclosed methods and systems. The components in the drawings are not necessarily to scale, with emphasis instead placed upon clearly illustrating the principles of the present disclosure. Like reference numerals refer to the same parts throughout the different drawings.

FIG. 1 depicts an example networked environment, in accordance with some embodiments of the present disclosure, in which multiple data sources, user devices, and a system can communicate via a communication network.

FIG. 2 shows a block diagram of an exemplary system associated with a digital platform, including processor 202, memory 204, interfaces 206, client devices 212, data stores 210A-210C, and a semantic progression engine 208 comprising modules 208-1 through 208-6.

FIG. 3 illustrates an example base knowledge graph with a superposed per-user familiarity overlay and example forward, skipped, and lateral progression regions relative to a selected dimension of interest.

FIG. 4 is a flowchart of an example method for initializing and producing a versioned base knowledge graph: provisioning data stores; registering sources; ingesting raw content; canonicalizing tags/keywords; computing features and typed edges; clustering and validation; persisting a versioned snapshot; and exposing read interfaces for downstream components.

FIG. 5 depicts an exemplary computer system that may be used to implement or support the disclosed methods and systems, illustrating processor(s), memory, external storage, and communication port(s).

FIG. 6 illustrates a cold-start progression-layer initialization/progression-layer update workflow in which the system computes the familiar set, derives the forward, skipped, and lateral regions, and ranks candidates per the definitions and equations described herein.

FIG. 7 illustrates an incremental update workflow following a user action, including delta-updating the user backbone and disjoint region bitsets and updating one or more affected progression-related constructs, including updating impacted candidate sets and/or re-ranking impacted candidates.

FIG. 8 illustrates an example embodiment 800 in which the semantic progression layer is presented using two progression-related regions rather than three. In this two-region embodiment, region membership is determined by predicate-based tests relative to a user anchor and a selected dimension of interest d(·), rather than by any geometric boundary in the visualization. The user anchor 802 may comprise, for example, a current vantage node CUR selected in a user interface, one or more nodes of the user's familiar set S_u, and/or an anchor derived from the user backbone. A node n is classified as belonging to a forward region 804 when n is reachable from the anchor by at least one qualifying traversal that is monotone increasing in the selected dimension of interest, for example a traversal (v_0, v_1, . . . , v_m) with v_0=CUR (or v_0∈S_u) and d(v_{i+1})>d(v_i) for successive nodes along the traversal, subject to any exclusions applied herein (e.g., excluding nodes already designated as familiar). A node n is classified as belonging to a backward region 806 when n precedes the anchor on the selected dimension of interest and n is connected to the anchor by prerequisite-typed edges or other edges typed for the selected dimension, for example when d(n)<d(CUR) (or d(n)<d(s) for some s∈S_u). Nodes that do not satisfy the forward predicate or the backward predicate may be classified as unassigned to either region and, in certain views, may be omitted from the two-region presentation for clarity. Accordingly, the apparent separation between forward and backward portions of FIG. 8 is an illustrative consequence of the predicate-based membership tests and the selected dimension of interest, rather than an arbitrarily drawn line in the diagram.

In some embodiments, the progression view is configured to compute exactly two predicate-defined regions relative to an anchor (e.g., a forward region and a backward region), and does not require computing a lateral region. In such two-region embodiments, a node that satisfies neither the forward predicate nor the backward predicate may be treated as unassigned (or assigned to a neutral/none class) and may be omitted from a rendered view for clarity, or alternatively may be displayed using a neutral styling. The absence of a lateral region in a given view therefore reflects an embodiment selection (e.g., a two-region mode) rather than a limitation of the disclosed techniques.

In some embodiments, the progression view is configured to compute exactly one predicate-defined region relative to the anchor, rather than computing two or more regions. By way of example, the system may operate in a forward-only configuration in which only the forward predicate is evaluated and only the forward region is computed and served, while the backward predicate is not evaluated and no backward region is computed for that view. In other embodiments, the system operates in a backward-only configuration in which only the backward predicate is evaluated and only the backward region is computed and served, while the forward predicate is not evaluated and no forward region is computed for that view. Accordingly, references herein to “one or more predicate-defined regions” include embodiments in which a single region is computed and used to generate the progression view.

In single-region embodiments, candidate nodes that do not satisfy the evaluated predicate for the computed region may be treated as unassigned and may be omitted from a rendered view for clarity, or alternatively may be displayed using a neutral styling, without requiring computation of any additional region to account for such nodes.

As used herein, “reachable” for purposes of region membership may refer to constrained reachability under one or more traversal constraints, including without limitation: a monotonicity constraint on a selected dimension of interest (e.g., strictly increasing or strictly decreasing), a hop limit, a cost or score budget, an edge-threshold constraint, or selection of a highest-scoring/lowest-cost traversal among multiple candidate traversals. Accordingly, the fact that a node may be connected to a goal by some path does not require that the node satisfy the membership predicate unless a qualifying traversal exists under the configured constraints.

The geometric arrangement shown in the figures is illustrative and may be produced by a layout algorithm (e.g., radial, layered, force-directed) that maps graph structure to screen coordinates. Region membership is computed by the predicate-based membership tests described herein and is not determined by screen position, a drawn boundary, or a visual partition. Any apparent separation of regions in a depiction is an illustrative consequence of applying the predicates and/or omitting unassigned nodes, rather than a requirement to draw a geometric boundary.

In other embodiments, one or more additional predicate-defined regions may be computed in addition to the forward and backward regions, such as a lateral region that includes nodes within a bounded neighborhood of the anchor and within a tolerance band of the dimension of interest, thereby supporting three or more regions. The choice to include or omit such additional regions may be controlled by configuration, user interface selection, or the type of output being generated.

As used herein, a progression view may be generated based on at least one predicate-defined region, including embodiments in which the view is generated from only a forward region or only a backward region, and embodiments in which the view is generated from both forward and backward regions and optionally one or more additional regions.

The foregoing, together with the following detailed description, will provide a thorough understanding of the methods, systems, and computer-readable media disclosed herein.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

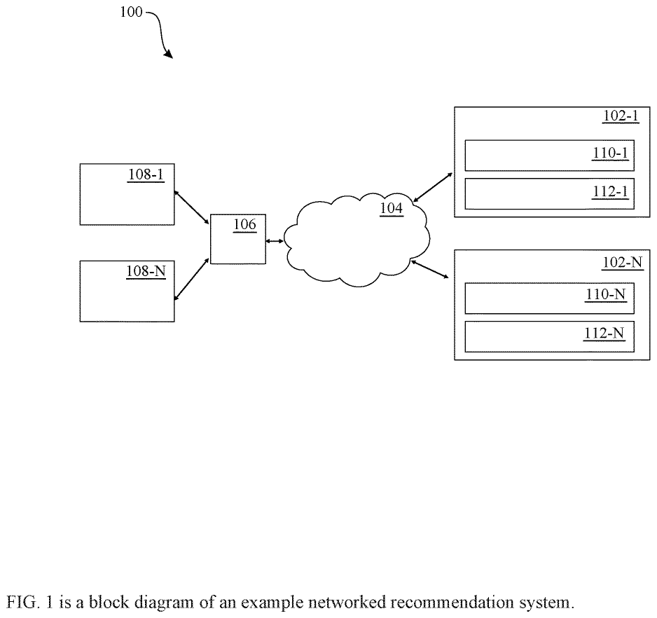

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In the following description, certain specific details are set forth in order to provide a thorough understanding of various disclosed implementations. However, one skilled in the relevant art will recognize that implementations may be practiced without one or more of these specific details, or with other methods, components, materials, and the like.

Unless the context requires otherwise, throughout the specification and claims which follow, the word “comprise” and variations thereof, such as, “comprises” and “comprising” are to be construed in an open, inclusive sense that is as “including, but not limited to.”

As used in this specification and the appended claims, the singular forms “a,” “an,” and “the” include plural referents unless the content clearly dictates otherwise. It should also be noted that the term “or” is generally employed in its broadest sense that is as meaning “and/or” unless the content clearly dictates otherwise.

The headings and Abstract of the Disclosure provided herein are for convenience only and do not interpret the scope or meaning of the implementations.

Definitions—graph primitives. A base knowledge graph G=(V, E) stores nodes V and typed edges E, including prerequisite-typed edges and optionally other semantic edge types such as part-of, similarity, association, co-occurrence, and inferred relationships. A “root” node has no incoming prerequisite-typed edge. A “path” is an ordered sequence of nodes connected by edges, which may be restricted to a selected edge family depending on the operation being performed.

Dimension of Interest/DoI. A dimension of interest (DoI) is an ordered node attribute d defined over V (e.g., prerequisite depth, difficulty level, curriculum level, or time sequence). Node a precedes node b on DoI d if d(a)<d(b). In certain embodiments, precedence and progression are evaluated subject to a configured edge family (e.g., prerequisite-typed edges), such that the system may additionally require the existence of a qualifying traversal connecting a to b under the configured constraints.

Familiarity score. For user u and node n, a familiarity score F(u, n) is computed by weighting consumption, assessment, and dwell-time signals, applying a recency-decay factor, and bounding the result to [0, 1]. A node is “familiar” for user u when F(u, n)≥τ. In one example,

$$F ( u , n ) = clip ( α \cdot consumption ( u , n ) + β \cdot assessment ( u , n ) + γ \cdot dwell ( u , n ) ) \cdot ρ ( Δ t ) ,$$

where ρ(Δt)=exp(−λ·Δt), Δt denotes elapsed time since the user's most recent interaction with node n, and α, β, γ, λ, and τ are tunable parameters. As used in the claims, τ (tau) denotes the familiarity threshold and δ (delta) denotes the lateral tolerance.

Superposed per-user graph. A superposed graph G_u overlays the base graph with the user's familiar nodes S_u={n∈V|F(u, n)≥τ} and one or more connecting structures derived from the prerequisite subgraph. In some embodiments, the connecting structure comprises a user backbone formed by selecting, for each familiar node, at least one prerequisite path to a root (e.g., a shortest path under a configured cost), and storing the union of such paths as described herein. In other embodiments, the connecting structure comprises a transitive prerequisite closure, a spanning structure, or another compact representation sufficient to support coverage and eligibility computations.

Path direction. As used herein, “drawing one or more paths from one or more root nodes” includes generating paths by (i) forward traversal starting at a root node, and/or (ii) reverse traversal from a user-familiar node to a root node along directed prerequisite edges, where the reverse traversal yields the same ordered path when read in reverse.

Region definitions. In three-region embodiments, relative to G_u and DoI d: (i) Forward region: nodes reachable from any familiar node by at least one qualifying traversal that is monotone increasing in d, excluding familiar nodes and excluding nodes assigned to a backward-looking region under the configured precedence; (ii) Backward-looking region (also termed skipped): nodes that precede at least one anchor node (e.g., a familiar node and/or a designated vantage node) on d and that fail a familiarity or mastery predicate (e.g., F(u, n)<τ and/or M(u, n)<θ) under configured edge-family constraints (e.g., prerequisite-typed edges); and (iii) Lateral/adjacent region: nodes within k hops of an anchor whose DoI differs by at most δ, i.e., |d(n)−d(s)|≤δ, excluding nodes assigned to familiar, forward, or backward-looking regions. In two-region embodiments, the lateral/adjacent region may be omitted and nodes that satisfy neither forward nor backward-looking predicates may be treated as unassigned as described herein.

Terminology; synonyms. As used herein, the terms “forward” and “ahead” are used interchangeably to refer to progression-related nodes beyond a user's current familiarity along a selected dimension of interest. Similarly, “skipped” and “backward-looking” (or “backward”) are used interchangeably to refer to prerequisite or preceding nodes not detected among the user's visited or consumed content. “Lateral” may also be referred to as “adjacent” and refers to nodes that broaden exploration relative to explored regions. These terms are used for clarity of explanation and do not limit the scope of the disclosure.

For the avoidance of doubt, “backward region” as used herein includes embodiments in which the backward-looking set corresponds to unmet prerequisites or preceding nodes and may be termed “skipped.” In anchor-relative embodiments, the backward region may be computed using predicate-based tests relative to the anchor and a selected dimension of interest, and is not limited to any particular user-history representation beyond what is required to evaluate the predicate(s) for that view.

Disjointness; stored representation. In some embodiments, when multiple regions are computed, the forward region, skipped region, and lateral region are computed and maintained as pairwise disjoint regions for deterministic presentation and auditability. In one implementation, disjointness is enforced by an exclusion precedence: (i) compute the skipped set; (ii) compute the forward set while excluding skipped nodes and familiar nodes; and (iii) compute the lateral set while excluding familiar nodes and excluding the union of skipped and forward nodes. In certain embodiments, region membership is stored as three bitsets over a stable node-identifier space (FWD[u], SKIP[u], LAT[u]) that satisfy the pairwise-disjointness invariants:

$$FWD [ u ] ⋂ SKIP [ u ] = ∅ ; FWD [ u ] ⋂ LAT [ u ] = ∅ ; and$$

$$SKIP [ u ] ⋂ LAT [ u ] = ∅ .$$

In such embodiments, when a node satisfies criteria for multiple regions, the node is assigned to exactly one region according to the exclusion precedence.

Although certain embodiments describe progression using three discrete and pairwise-disjoint regions, other embodiments may represent progression using continuous scores, weighted factors, or unified ranking functions derived from user-specific signals. In such embodiments, discrete regions may be computed as a view, partition, or interpretation of an underlying continuous representation, and implementations may present either discrete sets, continuous gradients, or unified ranked sequences. These variations remain consistent with the underlying semantic progression layer and are within the scope of the present disclosure.

Notation. Let G=(V, E) be the base knowledge graph with a dimension of interest d: V→ [symbol] (e.g., prerequisite depth or difficulty), where [symbol] denotes the set of real numbers. For user u and node n, familiarity F(u,n) is in [0,1]. Threshold τ defines familiarity; k in N is a hop limit; δ is a lateral tolerance used only in the lateral membership test. Define Δd(n,s)=|d(n)−d(s)|. A “root” has no incoming prerequisite edge. “Familiar” means F(u,n)≥τ. N denotes the non-negative integers. For any node x∈V, prereqs(x)⊆V denotes the set of immediate prerequisite nodes of x, i.e., {p∈V:(p, x)∈E and the edge is typed “prerequisite”}. Unless stated otherwise, coverage_gain(·) in Eq. (2) is computed with respect to prereqs(x). In some embodiments, a transitive prerequisite closure (e.g., prereqs_plus(x)) may be used instead; references to prereqs(x) herein are to the immediate set unless explicitly noted.

### Equation (1)—Familiarity.

Let cons (u,n), verify (u,n), and dwell (u,n) be normalized signals, where verify encompasses any measurable evidence of comprehension (e.g., task outcomes, reviews, spaced-repetition results, or quizzes). Let ρ(Δt)=exp(−λ·Δt) be a recency decay (λ≥0). With clip(·) bounding to [0,1]:

$$F ( u , n ) = clip ( α \cdot cons + β \cdot verify + γ \cdot dwell ) \cdot ρ ( Δ t ) , with α , β , γ \geq 0.$$

(Setting any weight to 0 disables that signal—e.g., B=0 removes quizzes/verification entirely.)

### Equation (2)—Ranking.

For candidate x:

Score(x)=L1·goal_sim(x,G_u)+L2·coverage_gain(x)+L3·(1−F(u,x))−L4·redundancy(x),

where coverage_gain(x)=|prereqs(x)∩S_u|/max(1, |prereqs(x)|), i.e., the fraction of x's prerequisites that are already satisfied by the user's familiar set/backbone.

Multi-dimensional dimensions of interest. In some embodiments, progression is defined with respect to a plurality of dimensions of interest rather than a single scalar. For node n, a dimension-of-interest vector d\vec{ }(n)=(d₁(n), d₂(n), . . . , d_m(n)) is stored, where each component dⱼ(n) is an ordered attribute such as difficulty, time cost, curriculum level, exam relevance, goal distance, prerequisite depth, or recency. For each component dⱼ(·), a direction of preference is configured (e.g., “larger is more advanced” or “smaller is more desirable”), and the system normalizes comparisons accordingly. In one implementation, each dimension is compared using a normalized form dⱼ′(·) such that “smaller is better” for dominance tests (e.g., by negating dimensions for which larger values are preferable). A node a is said to dominate node b if, for all j, dⱼ′(a)≤dⱼ′(b) and for at least one j, dⱼ′(a)<dⱼ′(b). A node is Pareto efficient (non-dominated) if no other node in a candidate set dominates it. In some embodiments, a scalar dimension of interest d(·) is still used for region definitions, while d\vec{ }(·) is used to compute multi-dimensional frontiers for selection and visualization.

### Equation (3)—Multi-Dimensional Domination; Scalar Projection.

In multi-dimensional embodiments, each node n has a dimension-of-interest vector d\vec{ }(n)=(d₁(n), . . . , d_m(n)) as described above. For two nodes a and b in a candidate set C, a is said to dominate b (denoted a>b) if:

$$d\_j ( a ) \leq d\_j ( b ) for all j ∈ \{ 1 , … , m \} and$$

$$d\_k ( a ) < d\_k ( b ) for at least one k .$$

In some embodiments, a scalar projection score P(n) is additionally computed from d\vec{ }(n) to order or band nodes on the frontier, for example:

$$P ( n ) = {\sum }_{j} {w}_{j} \cdot d\_j ( n ) ,$$

where wⱼ≥0 are configuration weights that may be learned or manually specified. Non-dominated nodes form a Pareto frontier; P(n) is used only for tie-breaking or presentation and does not alter the definition of domination.

Frontier bitset; candidate bitset; dimension score arrays. In multi-dimensional embodiments, a frontier bitset FRONT[u] is allocated per user as a bitset over V, where a set bit at position i indicates that the node with stable identifier i is currently classified as non-dominated (Pareto efficient) for that user and context. A candidate bitset CAND[u] may represent an intermediate candidate set for frontier computation. For each dimension of interest dⱼ, the system stores a dimension-specific score array scoresⱼ indexed by node identifier, holding the value dⱼ(n) (or normalized dⱼ′(n)) for each node n∈V. Frontier computation may proceed by performing dominance comparisons among nodes whose bits are set in CAND[u] using the score arrays, and clearing dominated nodes from CAND[u] until no further dominated nodes remain, after which the remaining set bits in CAND[u] are copied into FRONT[u]. Implementations may accelerate dominance checks using batching, indexing, partitioning, and/or block-wise bitset operations; the particular acceleration method is not limiting.

Uncertainty estimate; diagnostic candidate bitset; information gain. In some embodiments, in addition to familiarity or mastery scores, the system maintains an uncertainty estimate U(u, n) for user u and node n. The uncertainty estimate may be implemented as a variance parameter σ²(u, n) associated with the mastery score, as an entropy value over a discrete proficiency distribution, or as another scalar dispersion measure. A diagnostic candidate bitset DIAG[u] is maintained per user, containing one bit per node identifier; bits set in DIAG[u] mark nodes that are eligible to be used as diagnostic items. An expected information gain value IG(u, n) is computed for each node with DIAG[u] bit set, representing an expected reduction in global uncertainty (for example, a decrease in the sum of uncertainty estimates across nodes) given possible assessment outcomes at node n.

### Equation (4)—Expected Information Gain.

In diagnostic mode, for user u and node n, an expected information gain value IG(u, n) is computed from possible assessment outcomes o∈Ω (e.g., correct/incorrect or discrete score levels). Let p(o|u, n) denote the system's current estimate of the probability of outcome o for user u at node n, and let U_total(u) denote a global uncertainty metric for user u (for example, the sum of variances or entropies across a set of tracked nodes). Let U_total′(u|o, n) denote the updated uncertainty metric that would result if outcome o were observed at node n. One implementation defines:

$$IG ( u , n ) = \sum \_ \{ o ∈ Ω \} p ( o \vert u , n ) \cdot [ U\_total ( u ) - {U\_total}^{′} ( u \vert o , n ) ] .$$

Nodes with higher IG(u, n) are preferred as diagnostic candidates because they are expected to reduce global uncertainty more per diagnostic interaction.

Reward estimate; eligibility bitset; exploration bonus. In exploration-exploitation embodiments, each node n (or each group of nodes) is associated with a reward estimate \hat{r}(u, n) for user u, representing an expected outcome such as mastery gain, engagement, or satisfaction. A per-user eligibility bitset ELIG[u] contains one bit per node identifier and encodes graph-constrained gating conditions; a bit is set in ELIG[u] when the corresponding node satisfies prerequisite constraints, mastery thresholds, and any policy filters. A selection score S(u, n) is computed as a function of the reward estimate and an exploration bonus term B(u, n), such as S(u, n)=\hat{r}(u, n)+κ·B(u, n), where κ≥0 is a tunable exploration weight and B(u, n) may depend on the number of times node n has been recommended or on posterior uncertainty in \hat{r}(u, n).

### Equation (5)—Exploration-Exploitation Selection Score.

In exploration-exploitation embodiments, for user u and node n the system maintains a reward estimate \hat{r}(u, n) and a visitation count count(u, n) indicating how many times n has been selected. A selection score S(u, n) may be computed as:

$$S ( u , n ) = \hat{r} ( u , n ) + κ \cdot √ ( ln T ( u ) / ( 1 + count ( u , n ) ) ) ,$$

where κ≥0 is an exploration weight and T(u) denotes the total number of recommendation rounds performed so far for user u. The second term provides an exploration bonus that decays as count(u, n) increases. Other exploration bonus forms (e.g., Thompson sampling scores or posterior variance terms) may be used in place of the square root expression without departing from the scope of this disclosure.

Cohort-level region bitsets and objectives. In some embodiments, users are grouped into cohorts C⊆Users. For each user u∈C, user-specific region bitsets FWD[u], SKIP[u], and LAT[u] are maintained as described above. Cohort-level region bitsets are computed via bitwise aggregation, such as a cohort-union bitset FWD_union[C] whose bits are set when at least one user in the cohort has the corresponding bit set in FWD[u], and a cohort-intersection bitset FWD_intersect[C] whose bits are set when all users in the cohort have the corresponding bit set. Similar unions and intersections may be defined for SKIP and LAT. A cohort-level objective function J_C may be defined in terms of coverage of forward-region nodes, reduction of skipped-region nodes, and reduction of variance of mastery or familiarity across cohort members for nodes represented in the cohort-level bitsets.

### Equation (6)—Cohort-Level Objective.

For a cohort C of users and a set of nodes of interest V′⊆V, a cohort-level objective J_C may be defined in terms of skipped-region coverage and mastery variance. Let SKIP_union[C] denote a cohort-level skipped bitset as described herein, and let 1_{SKIP_union[C]}(n) be an indicator that is 1 when the bit for node n is set and 0 otherwise. Let M(u, n) be a mastery score for user u and node n, and let Var_C(n) be the variance of M(·, n) across u∈C. One example objective to be minimized is:

$$J\_C = α \cdot \sum \_ \{ n ∈ {V}^{′} \} 1 \_ \{ SKIP\_union [ C ] \} ( n ) + β \cdot \sum \_ \{ n ∈ {V}^{′} \} Var\_C ( n ) ,$$

where α, β≥0 are tunable weights. Recommendations that reduce J_C by decreasing the number of skipped nodes and/or reducing mastery variance across the cohort are preferred.

### Operational Definitions.

Def. D1 (Familiar set). S_u={n in V:F(u,n)≥τ} using Eq. (1).
Def. D2 (DoI & tunables). Inputs include: (i) the chosen dimension of interest d, threshold τ, hop limit k, and lateral tolerance δ; (ii) familiarity weights alpha, beta, gamma and the recency-decay parameter lambda for Eq. (1); and (iii) ranking weights L1 . . . . L4 and the Top-K value for Eq. (2). Any signal (e.g., verification/quizzes) may be disabled by setting its weight to zero; recency decay may be disabled by lambda=0. Implementations may choose the functional form of ρ(Δt) (e.g., exponential) and default values.
Def. D3 (Backbone). For each s in S_u, select a shortest path along prerequisite edges to a root; store the union of such paths as the user backbone. (One implementation uses Dijkstra over prerequisite edges with complexity O(|E|log|V|).)
Def. D4 (Region membership). Relative to S_u and d:
(i) SKIP: nodes that precede at least one familiar node on d and are not Familiar.
(ii) FWD: nodes reachable from any familiar node by a path with strictly increasing d, excluding Familiar and SKIP.
(iii) LAT: nodes within k hops of any familiar node with Δd(n,s)≤8, excluding Familiar and the union of SKIP and FWD.
Def. D5 (Vantage/Current). Let CUR denote the current vantage node v selected in the UI. CUR is an anchor (not a region). Region membership (SKIP, FWD, LAT) remains pairwise disjoint; CUR may coincide with a node in any region or outside all regions.

Parallel computation and reconciliation. In some implementations, candidate supersets are computed in parallel from a consistent snapshot of (i) the familiar set S_u, (ii) the dimension of interest d(·), and (iii) the base knowledge graph: SKIP* (a superset of prerequisite/preceding candidates), FWD* (a superset of forward candidates reachable under increasing d), and LAT* (a superset of lateral candidates satisfying hop and tolerance criteria). After parallel discovery, pairwise disjointness is enforced by reconciliation to yield the same result as the exclusion-precedence evaluation:

$$SKIP = SKIP * \backslash S\_u ;$$

$$FWD = FWD * ∖ ( S\_u ⋃ SKIP ) ; and$$

$$LAT = LAT * ∖ ( S\_u ⋃ SKIP ⋃ FWD ) .$$

In bitset implementations, these subtractions are performed using block-wise AND-NOT operations.

### Stored Representation & Disjointness.

Inv. I1 (Pairwise disjointness). Region membership may be persisted as three region bitsets over V (FWD[u], SKIP[u], LAT[u]) satisfying: (i) FWD[u]∩SKIP[u]=Ø; (ii) FWD[u]∩LAT[u]=Ø; and (iii) SKIP[u]∩LAT[u]=Ø. In certain embodiments, disjointness is enforced by computing SKIP first, then computing FWD excluding (SKIP∪Familiar), and then computing LAT excluding (SKIP∪FWD∪Familiar).

Example implementation of region bitsets. In one embodiment, each region bitset (e.g., FWD[u], SKIP[u], LAT[u]) is implemented as a contiguous array of machine words (e.g., 64-bit integers), where each bit position corresponds to a stable node identifier in V. Setting a bit marks the corresponding node as a member of the region; clearing a bit removes membership. Bitwise AND, OR, and AND-NOT operations over the arrays are used to intersect and subtract sets. In other embodiments, compressed bitset formats (e.g., Roaring bitmaps) or sharded bitsets may be used; the specific representation is not limiting.

Distributed implementations. The functional blocks shown in the figures (e.g., 202, 204, 206, 208-1 . . . 208-6, 210A-210C, 214) may execute on a single machine or be distributed across multiple machines, containers, availability zones, or geographic regions, communicating over one or more networks. Data stores (210A-210C) may be partitioned, sharded, or replicated with strong or eventual consistency. The event bus (214) may be any publish/subscribe or log-based system. References to “a processor,” “a memory,” or “a store” include one or more such elements; references to “module,” “engine,” or “service” encompass processes, services, or microservices deployed together or separately.

Semantic progression layer. As used herein, a “semantic progression layer” refers to the combination of (i) a base graph G populated with nodes and typed edges, (ii) user-specific familiarity signals and overlays (e.g., G_u, S_u, and any backbones), and (iii) progression-related constructs derived from these signals, such as region memberships, continuous scores, or unified ranking functions. The semantic progression layer may be consumed by downstream components, including but not limited to recommendation modules, visualization interfaces, LLM-backed assistants, and study-planning tools. As used herein, a ‘knowledge graph’ includes any graph-structured representation of topics, skills, content, entities, or relationships, and is not limited to any particular data model or storage system.

In some embodiments, the semantic progression layer is an intermediate computational layer that maintains per-user progression state over a base knowledge graph and exposes progression-related constructs (e.g., region memberships, eligibility sets, frontier sets, continuous scores, or ranked candidate sets) to one or more downstream components. Downstream components may generate recommendations, guidance, visualizations, navigation paths, schedules, assessments, or other outputs based at least in part on the progression-related constructs.

Mastery score; gating. In some embodiments, progression is modelled via a mastery score M(u, n) for user u and node n. The mastery score M(u, n) is updated from assessment events, quiz outcomes, or other verification signals using a rating update rule (e.g., an Elo-style update) of the form:

$${M}^{′} ( u , n ) = M ( u , n ) + η \cdot ( s - E [ M ( u , n ) ] ) ,$$

where n is a learning rate, s is an observed outcome score, and E[M(u, n)] is an expected performance estimate.

A prerequisite-gating function g(u, x) is defined for candidate node x, where g(u, x)=1 if, and only if, all prerequisite nodes p in prereqs(x) satisfy M(u, p)≥θ, for a mastery threshold θ, and g(u, x)=0 otherwise. In mastery-gated embodiments, only nodes x with g(u, x)=1 are eligible for recommendation or activation.

Mastery-oriented objective; pacing schedule. In mastery-centric embodiments, the system defines an objective function J over a sequence of recommended nodes (x₁, . . . , x_T) that accounts for expected mastery gain per unit time, such as:

$$J = {\sum }_{t} Δ M ( u , {x}_{t} ) / cost ( {x}_{t} ) ,$$

where ΔM(u, xₜ) denotes an expected increase in mastery from engaging with xₜ and cost(xₜ) denotes an estimated time or effort cost. A pacing schedule P(u, t) specifies, for time intervals t, a subset of nodes or topics allocated to those intervals, subject to the prerequisite-gating function g(u, ·) and time or workload constraints.

Curriculum field/potential function. In some embodiments, progression is represented as a scalar curriculum field Φ(u, n) defined for user u and node n in V. The field Φ(u, n) aggregates user-specific signals (e.g., familiarity, mastery, goal similarity, recency, prerequisite status, and time constraints) into a single scalar value that reflects, for example, urgency, expected mastery gain, or curriculum potential at node n. A higher value of Φ(u, n) indicates that n is a more suitable next step for user u.

A curriculum trajectory for user u is a walk (n₀, n₁, . . . , n_T) over the graph such that successive nodes approximate following the graph-gradient of the curriculum field, e.g., Φ(u, nₜ₊₁)≥Φ(u, nₜ) subject to constraints such as prerequisite satisfaction and time budget. In some embodiments, discrete region labels (forward, skipped, lateral) are not computed, and recommendations are generated solely from the curriculum field Φ(u, ·) and local graph neighborhoods.

Shown throughout the figures, the present disclosure is directed to computer-implemented systems and methods that maintain a semantic progression layer over graph-structured data, with a focus on identifying efficient paths of progression relative to a user's goals. In some embodiments, this semantic progression layer underlies one or more recommender systems that consume its outputs.

The various embodiments throughout the disclosure will be explained in more detail with reference to FIGS. 1-5.

FIG. 1 shows an exemplary networked environment 100, in accordance with some embodiments of the present disclosure.

With reference to FIG. 1, the networked environment 100 may include a system 106, a plurality of user devices (102-1 . . . 102-N) associated with a plurality of users (not shown), and a plurality of data sources (108-1 . . . 108-N). It may be appreciated that the user devices (102-1 . . . 102-N) may be individually referred to as the user device 102 and collectively referred to as the user devices 102, and the data sources (108-1 . . . 108-N) may be individually referred to as the data source 108 and collectively referred to as the data sources 108. A person of ordinary skill in the art will understand that there may be any number of user devices 102 and/or data sources 108 within the scope of the present disclosure.

In some embodiments, each user device 102 comprises a digital platform (110-1 . . . 110-N) communicatively coupled with the system 106. In some embodiments, the digital platform (110-1 . . . 110-N) may be a mobile application (“app”). The mobile application may be installed on the user device 102. In some embodiments, the digital platform (110-1 . . . 110-N) may be a web application (e.g., a website or a webpage). In some embodiments, the digital platform (110-1 . . . 110-N) may be a desktop application. The digital platform (110-1 . . . 110-N) in conjunction with a processing unit (112-1 . . . 112-N) may render a graphical user interface on the user device 102 such that a user of the user device 102 may communicate with the system 106 via the graphical user interface rendered on the user device 102. The graphical user interface may be rendered on the user device 102 under control of the system 106. In some embodiments, the digital platform (110-1 . . . 110-N) may be hosted on the system 106.

Referring to FIG. 1, the system 106 may be communicatively coupled to the plurality of user devices 102 via a communication network 104. In some embodiments, the system 106 may include suitable logic, circuitry, interfaces, and/or code to receive user inputs or requests from each of the plurality of user devices 102 associated with the plurality of users. By way of example and not limitation, such user inputs may include professional information (e.g., employment history, skill assessments, or career goals), academic data (e.g., courses taken, degrees pursued, or learning objectives), personal project details (e.g., open-source contributions, coding platforms, or creative portfolios), and overall content-consumption history (e.g., videos watched, articles read, or online courses accessed on various platforms). In certain embodiments, the user input may also capture broader contextual information—such as time constraints or specific learning milestones—to facilitate more tailored recommendations. A person of ordinary skill in the art will appreciate that additional categories or variants of user input may be incorporated without departing from the scope of the present disclosure, and any sensitive data may be anonymized or handled according to applicable privacy regulations.

Referring to FIG. 1, examples of the system 106 may include, but are not limited to, a computer workstation, a mainframe computer, a handheld computer, a cellular/mobile phone, and other computing devices. In some embodiments, the system 106 may be implemented as a cloud server which may execute operations through web applications, cloud applications, Hypertext Transfer Protocol (HTTP) requests, repository operations, file transfer, and the like. Other examples of the system 106 may include, but are not limited to, a database server, a file server, a web server, a media server, an application server, a mainframe server, a cloud server, or other types of servers. In some embodiments, the system 106 may be implemented as a plurality of distributed cloud-based resources by use of several technologies that are well known to those skilled in the art.

In some embodiments, each of the plurality of user devices 102 may include suitable logic, circuitry, interfaces, and/or code that may be configured to receive the user input from the corresponding user. Specifically, each of the plurality of user devices 102 may be configured to receive the user input from the corresponding user and transmit the received user input to the system 106.

Examples of each of the plurality of user devices 102 may include, but are not limited to, a telephone, a smartphone, a cellular phone, a mobile phone, a personal digital assistant (PDA) device, a tablet, a gaming device, a computing device, an imaging device, a mainframe machine, a server, a computer work-station, and the like. In some embodiments, the plurality of user devices 102 may include, but is not limited to, any electrical, electronic, electro-mechanical, or an equipment, or a combination of one or more of the above devices such as virtual reality (VR) devices, augmented reality (AR) devices, a general-purpose computer, desktop, personal digital assistant, mainframe computer, or any other computing device, wherein the plurality of user devices 102 may include one or more in-built or externally coupled accessories including, but not limited to, a visual aid device such as camera, audio aid, a microphone, a keyboard, and input devices for receiving input from the corresponding user such as touch pad, touch enabled screen, electronic pen, and the like.

A person of ordinary skill in the art will appreciate that the plurality of user devices 102 may not be restricted to the mentioned devices and various other devices may be used.

In some embodiments, each user device of the plurality of user devices 102 may include a display device. The display device may include suitable logic, circuitry, and interfaces that may be configured to display the user input(s), confirmation message, user information, or the like. The display device may be further configured to display a set of user interface (UI) elements to receive the user input and/or request. The display device may be a touch screen which may enable the corresponding user to provide the user input via the display device. The touch screen may include, but not be limited to, a resistive touch screen, a capacitive touch screen, or a thermal touch screen. The display device may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with some embodiments, the display device may refer to a display screen of a head mounted device (HMD), a smart-glass device, a see-through display, a projection-based display, an electro-chromic display, or a transparent display.

Referring to FIG. 1, the communication network 104 may include a communication medium through which the system 106 and the plurality of user devices 102 may communicate with each other. The communication network 104 may be a wired or wireless communication network. Examples of the communication network 104 may include, but are not limited to, the internet, a cloud network, a Wireless Fidelity (Wi-Fi) network, a Personal Area Network (PAN), a Local Area Network (LAN), or a Metropolitan Area Network (MAN). Various devices in the networked environment 100 may be configured to connect to the communication network 104, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), HTTP, File Transfer Protocol (FTP), wireless access point (AP), device to device communication, cellular communication protocols, and Bluetooth (BT) communication protocols, or the like.

The networked environment 100 may also include a plurality of data sources 108 that may provide data to the system 106. In an example embodiment, the data sources 108 may include, but are not limited to, banks and financial institutions, schools and educational institutions, government entities, social media platforms, facial recognition devices, health and fitness trackers, e-commerce platforms, email and communication tools, and the like.

In operation, the system 106 may be configured to expose outputs derived from one or more progression-related regions (e.g., two-region or three-region modes) in a knowledge graph relative to the history of data gathered from the user. In some embodiments, these outputs may include recommendations; in others, they may include visualizations, guided navigation, or other progression-oriented signals. By integrating data from multiple sources 108, the system 106 processes the data to provide personalized progression insights and recommendations, helping users achieve their goals.

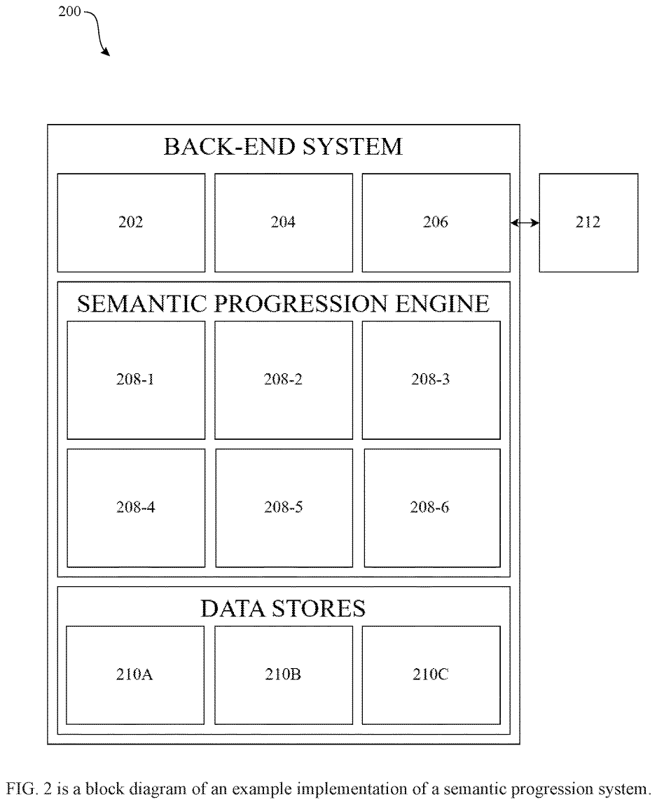

In some embodiments, a request (e.g., to optimize content consumption by the user) may be received from the user device (e.g., 102-1) via the digital platform 110-1 by the system 106. In response thereto, data from the plurality of data sources 108 may be collected by the system 106. The diverse data set provides a comprehensive view of the user's history. The system 106 may integrate the collected data into a centralized database (e.g., 210 of FIG. 2), ensuring that all relevant information is available for processing and analysis.

A base graph populated by internet-sourced content may be initialized by the system 106. This graph may be organized into an ontology that defines topics and sub-topics, potentially spanning multiple difficulty levels or prerequisite structures. For each user, a set of paths is drawn onto this base graph, starting from one or more “entry-level” content nodes, sub-topics, or topics that are low in a given dimension of interest (e.g., difficulty, prerequisite status). Even if a user's familiarity is scattered, sparse (i.e., covering isolated areas of the base graph), or non-existent, the system can still determine how to draw paths from root or prerequisite nodes. In some embodiments, in a three-region mode—“forward,” “skipped,” and “lateral”—are identified relative to these user-specific paths, enabling the system 106 to function as a semantic progression layer. Downstream components can use this layer to generate nuanced recommendations or other guidance. Consequently, this layered modeling approach provides the user with a more structured progression toward their learning or exploration goals. As used herein, ‘draw paths’ refers to computing graph traversals and/or storing traversal results (e.g., parent pointers or path unions), and does not require geometric drawing or a particular visualization layout.

In some embodiments, incoming data is added to the graph data structure in order to enrich both the base graph and any user-specific overlays. The data may include user preferences, goals, or schedules, as well as metadata derived from media content (e.g., via video and image transcription to extract relevant keywords). These keywords can be mapped to specific topics or sub-topics within the ontology. In certain implementations, an AI-driven or manually curated ontology may distinguish basic, intermediate, and advanced concepts as separate sub-graphs. Supervised learning techniques may further assist in classifying or tagging incoming content. Different sub-graphs or ontologies can coexist, reflecting various domains or knowledge hierarchies within the same overall structure.

In some embodiments, the ingested data can be categorized into two broad groups. The first group comprises data gathered from general internet sources—through web crawls or external APIs—that helps populate or expand the base graph. The second group comprises user-specific data, gathered from the user's own devices or connected platforms, which is processed before being mapped onto the base graph. This user-specific data forms a “superposed graph” that captures the user's current familiarity, interests, or progress relative to the base graph.

Once the user's superposed graph has been established (or updated), the system 106 may generate personalized progression signals—such as recommendations or other progression-related outputs—aimed at optimizing the user's content consumption. In some embodiments, the system computes one or more progression-related regions relative to a selected anchor and/or the user's familiar set. By way of example, in a three-region mode the system may highlight advanced content (“forward”) to deepen expertise, identify important foundational topics (“skipped” or backward-looking) that the user may have missed, and optionally suggest tangential or adjacent areas (“lateral”) for broadening the user's overall knowledge. In a two-region mode, the system may compute a forward region and a backward region without computing a lateral region, and nodes that satisfy neither predicate may be treated as unassigned and omitted from a rendered view for clarity or displayed using a neutral styling. In a single-region mode, the system may compute only a forward region or only a backward region for the selected view. By providing a clear roadmap of relevant topics, the system reduces knowledge gaps and helps guide the user toward a more structured learning or exploration experience.

Although FIG. 1 shows exemplary components of the networked environment 100, in other embodiments, the networked environment 100 may include fewer components, different components, differently arranged components, or additional functional components than depicted in FIG. 1. Additionally, or alternatively, one or more components of the networked environment 100 may perform functions described as being performed by one or more other components of the networked environment 100.

FIG. 2 shows a block-diagram representation 200 of an exemplary system 106, in accordance with some embodiments of the present disclosure.

Referring to FIG. 2, the system 106 may include one or more processors 202, memory 204, interface(s) 206, a semantic progression engine 208, and data stores 210A-210C. In some embodiments, the processor(s) 202 comprise suitable logic, circuitry, and interfaces configured to execute instructions for various operations performed by the system 106. By way of example and not limitation, such operations may include receiving user inputs, collecting and normalizing event signals, initializing and updating a base knowledge graph, superposing user-specific familiarity information onto that graph, computing region membership, and providing progression-related constructs and/or generating recommendations. The processor(s) 202 may also execute applications that expose network APIs to client devices (212) via interface(s) 206.

Data stores and external clients. The data stores include a graph store 210A holding nodes and typed edges (including prerequisite edges), a progression-construct store 210B holding one or more per-user progression representations for the selected operating mode (e.g., one or more region bitsets such as FWD and BACK/SKIP and optionally LAT, and/or other compact per-user constructs), and auxiliary store(s) 210C for logs, telemetry, audits, and feature flags. Interface(s) 206 provide network and I/O connectivity between the back-end system and client devices 212.

In some embodiments, the one or more processor(s) 202 may be implemented as one or more microprocessors, microcontrollers, DSPs, CPUs/GPUs/TPUs/ASICs, or other logic devices. Among other capabilities, the one or more processor(s) 202 may be configured to fetch and execute computer-readable instructions stored in the memory 204 of the system 106. The memory 204 may be configured to store one or more computer-readable instructions or routines in a non-transitory computer readable storage medium, which may be fetched and executed to create or share data packets over a network service. The memory 204 may store program code and working sets in non-transitory media, including, for example, volatile memory such as Random-Access Memory (RAM), or non-volatile memory such as Electrically Erasable Programmable Read-only Memory (EPROM), flash memory, and the like.

In some embodiments, the system 106 may include the interface(s) 206. The interface(s) 206 may comprise a variety of interfaces, for example, interfaces for data input and output devices, referred to as input/output (I/O) devices, storage devices, and the like. The interface(s) 206 may comprise I/O, storage, and network interfaces and may facilitate communication between system components and the plurality of client devices 212 & 701 over the communication network 104. The interface(s) 206 may also provide a communication pathway for one or more components of the system 106. Examples of such components include, but are not limited to, the processing engine(s) 208 & 703 and the data stores 210A-210C (graph store 705, region bitset store, auxiliary). In some embodiments, the database 210 may comprise data that may be either stored or generated as a result of functionalities implemented by any of the components of the system 106. The database 210 may store the user input. In some embodiments, the database 210 may store profiles associated with each of the plurality of users. In some embodiments, the database 210 may store the data collected from the data sources 108.

In some embodiments, the interface(s) 206 may include suitable logic, circuitry, and interfaces that may be configured to facilitate a communication between the processor(s) 202 and the plurality of user devices 102 via the communication network 104. The interface(s) 206 may be implemented by use of various known technologies to support wired or wireless communication of the system 106 with the communication network 104. The interface 206 may include an antenna, a radio frequency (RF) transceiver, one or more amplifiers, a tuner, one or more oscillators, a digital signal processor, a coder-decoder (CODEC) chipset, a subscriber identity module (SIM) card, a local buffer circuitry, and the like.

In an embodiment, the semantic progression engine 208 is implemented as software and/or circuitry that performs the functions described below. In examples, described herein, such combinations of hardware and programming may be implemented in several different ways. For example, the programming for the processing engine(s) 208 may be processor-executable instructions stored on a non-transitory machine-readable storage medium and the hardware for the one or more processor(s) 202 may comprise a processing resource (for example, one or more processors), to execute such instructions. In the present examples, the machine-readable storage medium may store instructions that, when executed by the processing resource, implement the processing engine(s) 208. In such examples, the user device 102 may comprise the machine-readable storage medium storing the instructions and the processing resource to execute the instructions, or the machine-readable storage medium may be separate but accessible to the user device 102 and the processing resource. In other examples, the processing engine(s) 208 may be implemented by an electronic circuitry.

In an exemplary embodiment, the semantic progression engine 208 comprises the following modules:
208-1 Familiarity Calculator. Computes familiarity scores F(u, n) per Eq. (1) from consumption, verification, and dwell-time signals with recency decay, and updates the familiar set Su.
208-2 Goal Mapping. Maps user-provided or inferred goals to one or more goal nodes in the knowledge graph.
208-3 Delta Update Engine. Upon a familiarity threshold crossing (τ) or a change in shortest-path parentage, writes region-bitset deltas to 210B and updates affected records.
208-4 Backbone Constructor. Selects shortest paths along prerequisite edges from familiar nodes to one or more roots and stores the union as the user backbone.
208-5 Region Detector detects one or more region memberships according to an operating mode (forward-only, backward-only, two-region, three-region), and when multiple regions are stored enforces disjointness among the stored regions.
208-6 Progression Construct Assembler/Output Interface. Ranks candidates per Eq. (2) (e.g., goal similarity, coverage gain, familiarity, redundancy) and produces region-specific candidate sets, ranked candidate sets, and/or progression-related constructs for downstream components.

In certain implementations, machine-learning components (e.g., classifiers for prerequisite inference or goal mapping) and data-ingestion pipelines operate behind interface(s) 206 and persist their outputs to 210A-210C; these supporting components are not required to be shown in FIG. 2.

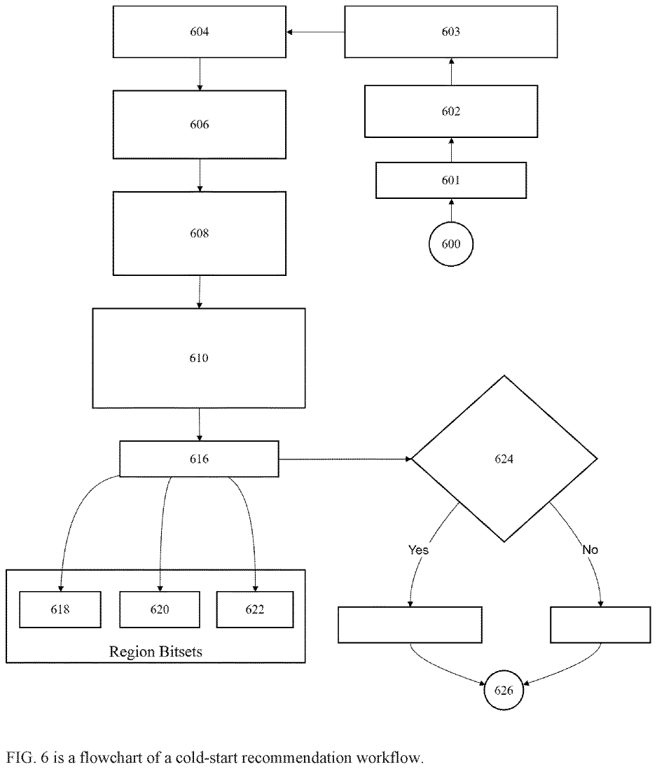

With reference to FIG. 6, the cold-start workflow 600 initializes one or more progression-related region constructs for a semantic progression layer from a consistent snapshot of (i) the user's familiar set S_u 601, (ii) the chosen dimension of interest d 602, and (iii) a configured edge family 603 (e.g., a prerequisite subgraph). In some embodiments, the system computes region membership 604 for at least a forward region and a backward-looking region (also termed skipped), and optionally a lateral/adjacent region, according to the configured operating mode. Where multiple regions are computed for a given view, the system enforces a deterministic assignment rule 606 (e.g., pairwise-disjoint membership under a configured precedence). One or more progression-related constructs are derived from the computed region(s) 608, including, for example, region bitsets, candidate-node sets identified by set bits, and/or a ranked list of candidate nodes 610 scored per Eq. (2), and are provided to one or more downstream components for generation of progression-related outputs, including recommendations, structured guidance, navigation cues, visualizations, or schedules.

In one embodiment, discovery of one or more region supersets proceeds in parallel 604 and reconciliation is performed by set subtraction 606 over the corresponding stored representations 616 (e.g., bitsets) to enforce the configured deterministic assignment rule for that view. By way of example, in a three-region mode the system may preserve a SKIP 618→FWD 620→LAT 622 exclusion precedence by subtracting overlaps in that order, while in a two-region mode the system reconciles membership between forward and backward regions (and may treat nodes satisfying neither predicate 624 as unassigned). In some embodiments, this reconciliation enables parallel execution and incremental bitset-delta writes for maintaining region membership at scale.

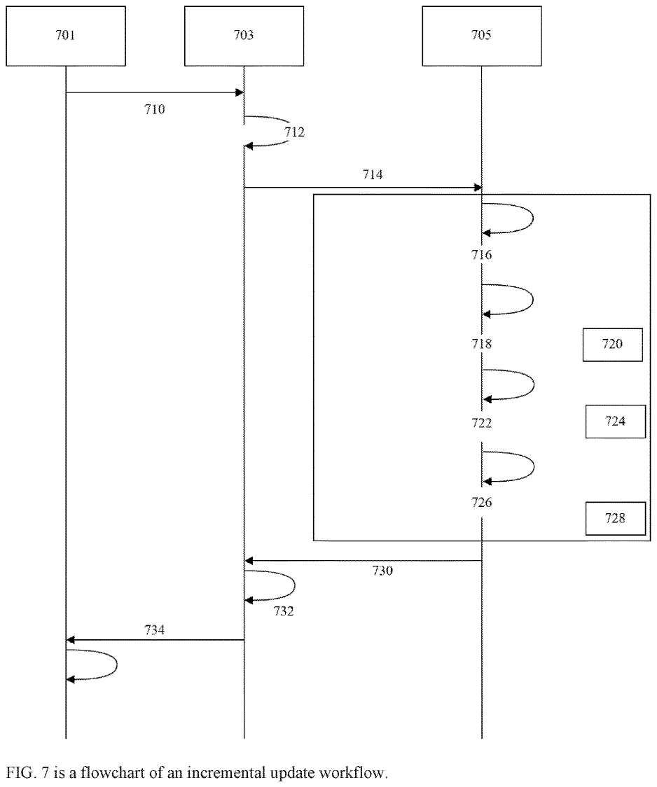

With reference to FIG. 7, after a user event 710—such as acceptance of a recommendation, completion of an assessment, or another interaction signal—the system applies an incremental recomputation 712. Nodes whose familiarity F(u,n) crossed the threshold τ or whose shortest-path parents changed are identified 714; the backbone union of shortest prerequisite paths is updated 716; and the stored region membership representation(s) for the selected operating mode (e.g., one or more region bitsets 720 & 724 & 728) receive delta writes localized to the affected neighborhoods, followed by updating one or more derived progression-related constructs, including updating impacted candidate sets and/or re-ranking impacted candidates 732 per Eq. (2). This limits traversal cost and reduces recomputation latency compared to full recomputation over V, while permitting implementations to recompute additional candidates when desired 718 & 726 (e.g., on refresh, on snapshot change, or under a diagnostic or exploration policy).

In certain implementations, a user event 710 triggers updates to coverage_gain(·) with respect to the updated backbone enabling immediate promotion of newly reachable forward candidates 722 while maintaining the configured deterministic assignment rule (e.g., pairwise disjointness when multiple regions are stored), and enabling downstream components to refresh one or more progression-related outputs 730 based on the updated progression-related constructs.

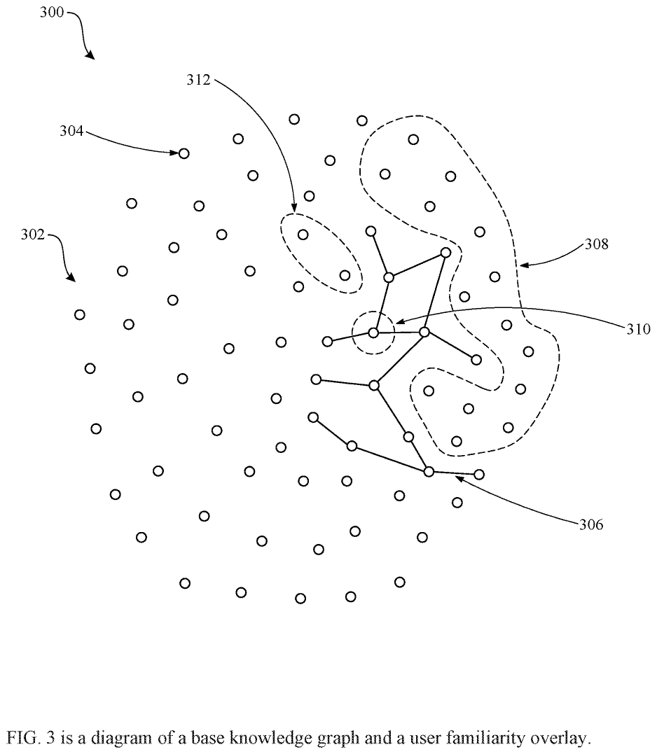

FIG. 3 shows a representation 300 of the base graph data structure with a superposed graph data structure representing a single user by the example system 106, in accordance with embodiments of the present disclosure.

Referring to FIG. 3, the representation 300 shows a graph 302 where edges between nodes are not shown. Each node 304 in the graph 302 represents a topic, sub-topic, or content on the internet that has been organized into a graph. The superposed per-user graph 306 (where edges between nodes are shown) represents topics, sub-topics, or content that the user is familiar with. Three areas become of interest for driving progression-related outputs. In one embodiment these outputs include recommendations, but other embodiments may employ the same regions to power visualizations, study plans, or interactive guidance. The first area 308 represents content that is more advanced and brings the user closer to their goals provided as input. The second area 310 represents content that the user should be familiar with but may have skipped according to their history and the progression of content defined in the graph. The third area 312 represents content that expands the user's breadth of content consumption. It should be noted that FIG. 3 depicts only one such sub-graph for illustrative purposes; in an actual implementation, the base graph may comprise many sub-graphs or interconnected regions representing various domains, levels, or subject areas. Region indices correspond as follows: 308—forward region, 310—skipped region, and 312—lateral region.

In the example of FIG. 3, the forward region 308 is illustrated under a configuration in which user-selected or inferred goal nodes correspond to higher values of a selected dimension of interest (e.g., greater prerequisite depth or difficulty), such that forward candidates represent advancement toward deeper or more difficult topics consistent with a mastery-oriented progression objective; other configurations may map goal nodes to intermediate levels or breadth-oriented outcomes, and the forward region and associated rankings may be computed accordingly.

By way of illustration, consider a user “ABC” who wishes to learn a new subject or skill but is unsure how to proceed. The user may not know which subtopics to explore first, how to filter content by difficulty, or even which queries to pose to a large language model. Seeking guidance, the user semantic progression system 106 via the digital platform 110-1. The user can input personal goals, learning preferences, or other parameters. Meanwhile, the system 106 may collect supplemental data from the user's connected sources (e.g., 108), such as relevant content platforms or online repositories. By aggregating these inputs, the system constructs a comprehensive profile of the user's existing familiarity across one or more subject domains-regardless of whether the user specifically filters by topic. This approach provides a more targeted roadmap for content consumption, ensuring that ABC receives recommendations aligned with both immediate knowledge gaps and longer-term objectives.

Despite the widespread adoption of knowledge graphs and machine-learning techniques in graph-driven systems, existing solutions often emphasize local similarity, proximity, or user-to-user correlation signals (e.g., collaborative filtering) to surface items. Such systems rarely provide a structured semantic progression layer that models a user's evolving familiarity or mastery across a multi-level graph and that exposes progression-oriented constructs—such as gaps, prerequisites, and forward reachability—usable to generate roadmaps, guided navigation, or other adaptive outputs. Consequently, many conventional systems fail to provide a cohesive path from foundational to advanced concepts, and instead operate as flat item-surfacing mechanisms that do not explicitly represent where the user is positioned within an overall semantic structure.

By contrast, the present disclosure provides a graph-based approach that overlays each user's familiarity state onto a base knowledge graph to form a per-user semantic progression layer. This layering enables the system to dynamically identify progression-related regions relative to one or more dimensions of interest, including: (1) a forward region representing nodes beyond the user's current familiarity along the dimension of interest, (2) a skipped region representing prerequisite or preceding nodes not detected as familiar, and (3) a lateral region representing adjacent nodes that expand breadth while remaining within a tolerance relative to the dimension of interest. These progression-related structures can be consumed by downstream components to generate progression-related outputs, such as ranked candidate-node sets, structured guidance, navigation cues, visual overlays, or recommendations.

Moreover, unlike approaches that rely predominantly on user similarity signals or content-based keyword matching, the disclosed system can incorporate heterogeneous user-specific signals—such as professional data, educational records, social-platform interactions, and other contextual signals—to model how topics, skills, or content nodes interrelate for a particular user. This integrated user-state modelling, combined with the dimension-of-interest concept (e.g., prerequisite structure, difficulty level, curriculum level, or time sequence), enables progression-related constructs and outputs that adapt over time as the user's familiarity, context, and objectives evolve, rather than merely surfacing items that are superficially aligned with prior behavior.

The synergy between the base knowledge graph, the user's superposed familiarity overlay, and the threefold categorization of forward, skipped, and lateral regions is thus distinct from systems that only compute similarity or correlation rankings. This architecture reduces directionless surfacing by explicitly representing what prerequisite material may be incomplete, what forward candidates are reachable for advancement, and what adjacent areas can broaden understanding. In doing so, the present disclosure provides a comprehensive, goal-oriented semantic progression layer that supports multiple downstream progression-related outputs—including, but not limited to, recommendations—while maintaining explainability regarding why particular nodes are surfaced relative to the user's position in the graph.

In some embodiments, the system identifies “skipped” areas in the superposed graph by comparing the user's visited nodes against at least one preceding node in the dimension being traversed. More specifically, if a parent or prerequisite node in that dimension was not detected among the user's visited or consumed content, the system marks that parent or prerequisite node as “skipped.” By way of non-limiting example, each node in the base knowledge graph may contain metadata indicating its direct predecessors or lower-level concepts in the relevant dimension. When the system detects that a user has visited an upper-level node but has no record of visiting one or more corresponding preceding nodes, those nodes are programmatically labeled as “skipped.” This helps guide the user to revisit foundational material and rectify knowledge gaps that might otherwise hamper progress through more advanced topics.

Furthermore, in some embodiments, the system determines which areas of the knowledge graph map to the user's stated or inferred goals, thereby identifying which nodes should be considered high-priority for the user's upcoming recommendations. The mechanism for translating the user's goals to specific nodes or sets of nodes in the knowledge graph may rely on factors such as topic relevance, user context, or additional metadata, but the internal details of that mapping process need not be disclosed herein. Once one or more nodes are flagged as aligning with the user's goals, the system can highlight forward-looking recommendations (i.e., higher-level on the dimension of interest) aimed at reaching those goal-related nodes and may further adapt the recommendation engine over time as the user's goals or context change.

Furthermore, in some embodiments, user goals may span multiple areas of the knowledge graph, in which case the system can map the user's stated objectives to a set of sub-graphs, nodes, or distinct regions. When a user's goals involve a broad domain or multiple interconnected topics, grouping these goals into one or more sub-graphs/regions can facilitate a cohesive set of recommendations across related nodes.

Goal sets and goal-directed traversal. In some embodiments, a user goal is mapped to one or more goal nodes forming a goal set G_goal⊆V rather than a single node. Goal-directed traversal and/or ranking may be performed relative to the goal set by defining a distance-to-goal function dist(n, G_goal)=min_{g∈G_goal} dist(n, g) over a selected edge family (e.g., prerequisite edges, part-of edges, or other typed edges), and preferring candidates that reduce dist(·, G_goal) subject to prerequisite and eligibility constraints. In one implementation, a conceptual super-goal node is connected to each node in G_goal by a zero-weight edge, and a shortest-path or best-first search (e.g., BFS, Dijkstra, A*, or bounded traversal) is executed from an anchor set (e.g., the user's familiar set S_u, backbone nodes, one or more roots, and/or a current vantage node CUR) to the super-goal node to obtain one or more paths, scores, or reachability relations usable for candidate selection, explanation, and/or ranking. The particular pathfinding algorithm, edge weights, and anchor selection are configurable and non-limiting.

It may be appreciated that the exemplary representation 300 may be modular and flexible to accommodate any kind of changes within the scope of the present disclosure.

Worked exampleweb framework learning. Let the DoI be prerequisite depth. Nodes include: JavaScript Fundamentals (0), ES6 Syntax (1), React Basics (2), React Hooks (3), React Router (3), TypeScript Basics (2), Redux State Management (4), Next.js Routing (4). Suppose F(u, n)≥τ for React Basics and React Hooks only. The system traces prerequisites to ES6 Syntax and JavaScript Fundamentals.

Detected regions. Using the procedures described herein:
Skipped: JavaScript Fundamentals; ES6 Syntax (each precedes a familiar node and is not familiar).
Forward: Redux State Management; Next.js Routing (strictly higher DoI reachable from familiar nodes).
Lateral: React Router; TypeScript Basics (within k hops of familiar nodes and with |d(n)−d(s)|≤δ).
   Top-ranked recommendations are {Redux, Next.js, React Router} for the goal “production-ready React apps.”

Scope of FIG. 3. FIG. 3 illustrates only one example sub-graph for clarity. In practice, the base knowledge graph may comprise numerous sub-graphs and cross-links; the depicted sub-graph is representative rather than exhaustive.

Expert-level illustration. By way of illustration, if a user has ten years of experience as a React developer, the forward region naturally emphasizes advanced, newly emerging materials rather than introductory topics. The system therefore surfaces forward candidates at higher levels of the chosen DoI (e.g., advanced patterns, performance tuning, novel libraries), while de-emphasizing foundational items already familiar to such a user.

Two-subset packaging. In some embodiments, each recommendation set (forward, skipped, lateral) is packaged into two subsets: (i) a material subset comprising consumables (e.g., videos, articles, documentation, code repositories); and (ii) a testing subset linking to external assessment resources (e.g., problem banks or coding judges). For MOOC-style courses (e.g., Coursera-type offerings), the testing subset may be self-contained within the course environment.

Single-list presentation with internal labels. In other embodiments, the forward/skipped/lateral labels are used purely internally. Externally, the system may present a single unified progression stream (for example, a ranked list of candidate nodes or content items), optionally with a user control to filter or toggle among views. Region membership remains an internal label used for scoring, tie-breaking, and auditability.

Topic-level and prompt-level recommendations. Recommendations may target topics (nodes) as well as specific content items. In some embodiments, recommendations are generated as LLM prompts that guide the user to explore a topic, test mastery, or create artifacts aligned to the node's learning objectives.

Anchor node (CUR) and local progression view. In some embodiments, progression-related constructs are computed relative to a selected anchor node A in the knowledge graph rather than (or in addition to) being computed relative to the user familiar set Sy. The anchor node A may be a current vantage node CUR selected in a user interface, a node selected by a downstream component, or another designated reference node. The resulting constructs may be served as a local progression view centered at A and refreshed as A changes during navigation.

Two-region membership predicates relative to an anchor. Relative to an anchor node A and a selected dimension of interest d(·), the system may compute a forward region FWD_{A} and a backward region BACK_{A} using predicate-based classification. In one implementation, FWD_{A} includes candidate nodes n that are reachable from A under one or more allowed edge types and that satisfy an increasing-d condition, and BACK includes candidate nodes n that are reachable from A under one or more allowed edge types and that satisfy a decreasing-d condition. Non-limiting examples of allowed edge types include prerequisite edges, part-of edges, and similarity or association edges, and the allowed edge types may be configured per view or per domain.

Increasing and decreasing conditions; monotonic variants. The increasing-d condition may be implemented in a non-limiting manner as: (i) requiring that at least one step along a traversal from A to n increases d(·), and/or (ii) requiring that values of d(·) are strictly increasing along an ordered traversal from A to n. Similarly, the decreasing-d condition may be implemented as: (i) requiring at least one step that decreases d(·), and/or (ii) requiring that values of d(·) are strictly decreasing along the ordered traversal. Implementations may select strict or non-strict variants, and may apply hop bounds, depth bounds, or edge-weight bounds to limit traversal cost.

Omission of non-classified nodes from the two-region view. In some embodiments, nodes that satisfy neither the increasing-d condition nor the decreasing-d condition relative to the anchor node Aare omitted from the two-region progression view for clarity and to reduce visual or computational clutter. Such omitted nodes may include nodes that are reachable from A only via traversals that do not reach nodes with d(·) values greater than d(A) or less than d(A) under the configured predicates. Accordingly, the displayed shape of the two-region view may arise from the predicate-based inclusion criteria rather than from a requirement that the full base graph be displayed.

Forward-only and backward-only operating modes. In some embodiments, the system operates in a forward-only mode in which only FWD_{A} is computed and presented (or prioritized) relative to A, and BACK_{A} is omitted or de-emphasized. In other embodiments, the system operates in a backward-only mode in which only BACK_{A} is computed and presented (or prioritized) relative to A, and FWD_{A} is omitted or de-emphasized. The selected mode may be user-configurable, context-dependent, or automatically selected based on a task objective (e.g., advancement versus remediation).

The selected operating mode (e.g., forward-only, backward-only, two-region, or three-region) may be determined per request, per session, per user preference, per domain, or per downstream task objective, and may change dynamically as the user navigates or as the system switches between advancement-oriented and remediation-oriented behaviors. The mode selection may therefore control which predicate(s) are evaluated and which predicate-defined region(s) are computed and presented for the progression view.

Local direction labels and direction values. In some embodiments, the system assigns local direction indicators relative to the anchor node A. By way of non-limiting example, a node n may be labelled “forward-directional” relative to A when n∈FWD_{A} and “backward-directional” relative to A when n∈BACK_{A}. In certain implementations, the system computes a signed direction value dir_{A}(n) that indicates whether a node is forward-directional or backward-directional and, optionally, indicates a magnitude based on a difference in the dimension of interest (e.g., d(n)−d(A)) and/or a path-based distance from A to n. These direction indicators may be used for visualization, filtering, ranking, navigation cues, and/or downstream progression-related outputs.

Goal sets and goal-directed two-region filtering. In some embodiments, a goal specification corresponds to a set of goal nodes G⊆V (a goal region) rather than a single node. The system may restrict or weight forward-directional candidates by whether they lie on, or improve, a path-based relationship from the anchor node A toward at least one goal node in G. In one implementation, a distance-to-goal function dist(n, G)=min_{g∈G} dist(n, g) is used, and forward candidates are preferred when they reduce dist(·, G) subject to the configured reachability and increasing-d predicates. Goal sets may be represented as an explicit node list, a goal bitset over stable node identifiers, or another equivalent representation.

Stored representation and incremental maintenance of two-region membership. In some embodiments, anchor-relative membership is stored as compact bitsets keyed by stable node identifiers, including an anchor-relative forward bitset FWD_{A} and an anchor-relative backward bitset BACK_{A}. When the anchor node changes (e.g., CUR changes), when the dimension-of-interest configuration changes, and/or when relevant edges or node attributes change, the system recomputes membership for a bounded local neighborhood around impacted nodes and applies delta writes that set and clear only affected bit positions. This incremental maintenance reduces repeated full-graph scans and enables low-latency refresh of local progression views.

In some embodiments, region membership is stored for only the region(s) actually computed for a given view or operating mode. For example, in a forward-only mode the system may store an anchor-relative forward bitset FWD_A without storing a corresponding backward bitset, and in a backward-only mode the system may store an anchor-relative backward bitset BACK_A without storing a corresponding forward bitset. In such embodiments, incremental maintenance via localized recomputation and delta writes applies to the stored bitset(s) in the same manner described herein, and does not require maintaining or updating a bitset for a region that is not computed for the selected mode.

Vantage-point recommendations; optional fourth set. In some embodiments, the three sets may be computed relative to the user's current browsing point in the graph (e.g., a node viewed in an extension or UI pane). An optional fourth set comprises recommendations anchored at the current node itself. In some embodiments, diagram (e.g., FIG. 6) depicts vantage-point centering and dynamic recomputation of the sets as the user navigates.

Spatial gradient view. In some embodiments, although the sets are computed to be pairwise disjoint at recommendation time, the underlying scoring can be rendered as a spatial gradient over the graph, visualizing increasing relevance or urgency (e.g., heat-map shading) while still outputting discrete sets or a unified ranked list.

Curriculum field mode (continuous potential field). In other embodiments, the semantic progression layer is instantiated as a continuous curriculum field Φ(u, n) over the graph instead of discrete forward, skipped, and lateral sets. The field Φ(u, n) aggregates signals such as goal similarity, expected mastery gain, recency, prerequisite satisfaction, and workload constraints into a single scalar value per node. At recommendation time, the system samples from nodes with locally maximal Φ(u, ·) in the user's neighborhood, or follows a discrete approximation to a gradient-ascent trajectory on Φ(u, ·), subject to prerequisite constraints and optional diversity or specialty filters.

In curriculum-field embodiments, FWD/SKIP/LAT may be omitted or used only as an optional interpretive view derived from Φ(u, ·). The primary outputs include: (i) heatmap visualizations over the graph that show high-potential regions; (ii) curriculum trajectories that trace increasing sequences of Φ(u, n) from current mastery regions toward goal nodes; and (iii) continuous priority scores attached to candidate nodes for use by recommendation, scheduling, or LLM-backed guidance modules.

Specialty decomposition. For domains with multiple specialties, each of the three sets may be decomposed per specialty (e.g., front-end, back-end, data-viz). Conversely, the UI may present a separate pane per specialty, each pane containing its own forward, skipped, and lateral subsets.

Live-update layering; heterogeneous context weighting; proprietary heuristics. In some embodiments, the system employs a layered, live-updating pipeline in which familiarity scores and region membership are recalculated as new user signals arrive. Heterogeneous user-context features (e.g., professional history, schedule constraints, device patterns) may be differentially weighted to modulate ranking. Certain weighting choices, thresholds, and tie-breakers are configurable and may vary by implementation; exemplary instantiations are provided herein.

Curriculum import as goals. Formal school curricula and syllabi may be imported and translated into graph structures; their terminal competencies and milestones become goal nodes against which forward progress is measured.

Meta-graph construction. In some embodiments, the base and/or per-domain graphs are produced by pre-processing multiple source graphs and statistical artifacts, such as co-occurrence graphs, prerequisite-inference graphs, citation/link graphs, and curated curricula. These are reconciled into a unified ontology via graph alignment and de-duplication.

Node verification via quizzes; Elo-style mastery. Nodes may be verified by mini-quizzes that include a latency penalty to discourage automated answering, yielding more reliable skill signals. Quiz outcomes update an Elo-style mastery score per node (and optionally per specialty), which in turn modulates familiarity F(u,n) and ranking.

Mastery-gated mode (hard prerequisite constraints). In some embodiments, the semantic progression layer operates in a pure skill-mastery mode in which prerequisite constraints are enforced as hard graph constraints and the primary state variable per node is a mastery score M(u, n) rather than a familiarity threshold. Mastery scores are updated using a rating update rule (e.g., an Elo-style update) as described in the Mastery score; gating discussion herein based on quiz outcomes, task performance, or other verification events. A gating function g(u, x) determines eligibility of a candidate node x: nodes for which any prerequisite p∈prereqs(x) has M(u, p)<θ are temporarily ineligible for forward progression and may instead be surfaced as remedial or review items.

In this mastery-gated mode, recommendations are generated by optimizing a mastery-oriented objective such as expected mastery gain per unit time, as described in the “Mastery-oriented objective; pacing schedule” discussion herein, under the gating constraints. Outputs may include: (i) mastery dashboards that visualize M(u, n) across topics or specialties; (ii) pacing schedules that assign topic clusters to calendar windows or session slots; and (iii) prerequisite-blocked indicators that explain why certain advanced nodes are not yet available. In some embodiments, the FWD, SKIP, and LAT regions are not computed as named sets; instead, the gating function and mastery-oriented objective fully determine progression.

Track completion and zooming. When a track reaches its terminal node, the system may zoom out to a higher-scope parent (topic cluster or specialty) and propose the next track. A diagram (e.g., FIG. 7) may depict multi-scale navigation and roll-up transitions between levels.

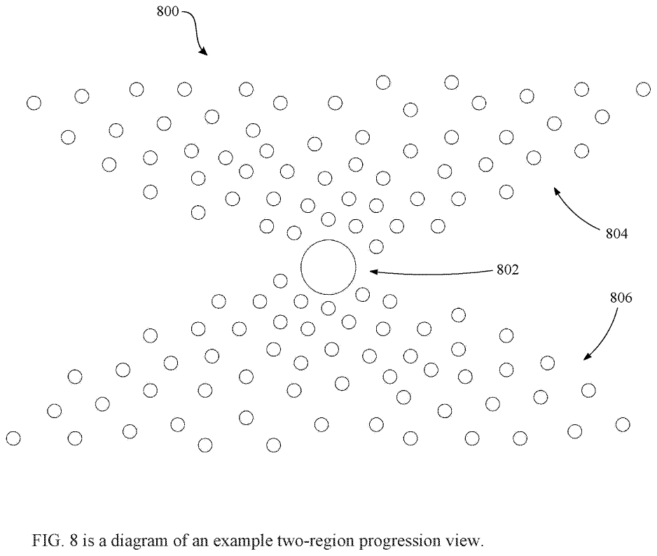

Lateral semantics and adjacency. As used herein, “lateral” may also be termed adjacent. Lateral membership may be determined by: (i) neighborhood within k hops in another dimension (e.g., peer difficulty at different sub-topics); and/or (ii) common-parent proximity, where the lateral distance is a function of the least common ancestor's depth. Diagram (e.g., FIG. 6 or FIG. 8) may illustrate both notions.

Review mode. A review-mode switch may bias recommendations toward areas of strength (high F(u,n)) for spaced-repetition reinforcement, rather than areas of weakness, with scheduling determined by decay ρ(Δt) and past performance.

Guided recursion to earlier nodes. The UI may display indications prompting users to recurse to an earlier node adjacent to the current root or sub-root when gaps are detected, thereby re-anchoring the backbone path for subsequent forward progress.

Pathfinding-based display. In some embodiments, the sets are displayed via pathfinding algorithms, such as k-shortest paths or constrained best-first traversals, to show how a recommendation connects to goals and which prerequisites it satisfies.

LLM-backed assistants. The graph may serve as a backend for LLM-based assistants, providing structured retrieval and constraint-aware guidance (e.g., mapping queries to nodes, teasing apart overloaded keywords, and maintaining topical coherence as context windows grow).

Interaction controls. A side panel may expose controls to order, sort, and filter the graph; adjust k, δ, and DoI; toggle forward/skipped/lateral views; pick specialties; and choose whether to show separate sets or a single unified ranked list.

Stateful movement. In some embodiments, selecting a forward, skipped, or lateral recommendation moves the user's position on the graph, instantly updating the superposed graph G_u and re-estimating region membership and rankings.

Mapping events to familiarity. User events-views, completions, quiz scores, and dwell time—are normalized to [0, 1] and combined per Eq. (1). A recency-decay factor down-weights older interactions. In one example, τ=0.6.

Backbone construction when familiarity is sparse. For each familiar node s∈S_u, the system performs a reverse traversal along prerequisite edges to a root, selecting the shortest path by hop count or by minimum total edge weight. The union of such paths forms a backbone that is stored for user u. In one embodiment, path selection is implemented with Dijkstra's algorithm with asymptotic complexity O(|E|log|V|) on the prerequisite subgraph.

Region detection; tunables; disjointness procedure. A region-detection procedure includes:
1. Compute S_u and the backbone as in Def. D1 and D3.
2. Skipped: for any familiar node b, if a preceding node a on DoI d exists and F(u, a)<τ, label a as skipped.
3. Forward: from each s∈S_u, traverse outward along edges with strictly increasing d; add first-layer (or path-bounded) nodes to the forward region, excluding familiar and skipped nodes.
4. Lateral: add nodes within k hops of any s with |d(n)−d(s)|≤δ, excluding S_u and the union of the skipped and forward sets. Parameters k∈ [symbol] and δ≥0 are tunable (typical values: k∈{1,2}, δ∈[0,2]).

Ranking. In some embodiments, a candidate x receives

$$Score ( x ) = L 1 \cdot goal\_sim ( x , G\_u ) + L 2 \cdot coverage\_gain ( x ) + L 3 \cdot ( 1 - F ( u , x ) ) - L 4 \cdot redundancy ( x ) ,$$

where goal_sim measures similarity to one or more goal nodes, coverage_gain is the fraction of x's prerequisite nodes newly satisfied with respect to the backbone, and redundancy penalizes near-duplicates to already-selected candidates. One enabled instantiation uses L1=0.5, L2=0.3, L3=0.2, L4=0.1 and coverage_gain(x)=|{p∈prereqs(x):p becomes satisfied if x is added}|/|prereqs(x)|. In some embodiments, Top-K recommendations are output per region; in others, a single unified ranked list is presented. Other embodiments may employ non-linear, learned, or multi-objective ranking functions. Top-K denotes selecting the K highest-scoring candidates for an integer K≥1 (e.g., K=10).

Incremental recomputation; latency. Upon acceptance of a recommendation, the system updates the user's position, adjusts F(u, n) for affected nodes, and incrementally recomputes the backbone and region bitsets by limiting traversal to nodes whose familiarity crossed τ or whose shortest-path parents changed. In one embodiment, limiting recomputation to the affected neighborhoods and applying bitset delta writes reduces recomputation latency compared to full recomputation over V.

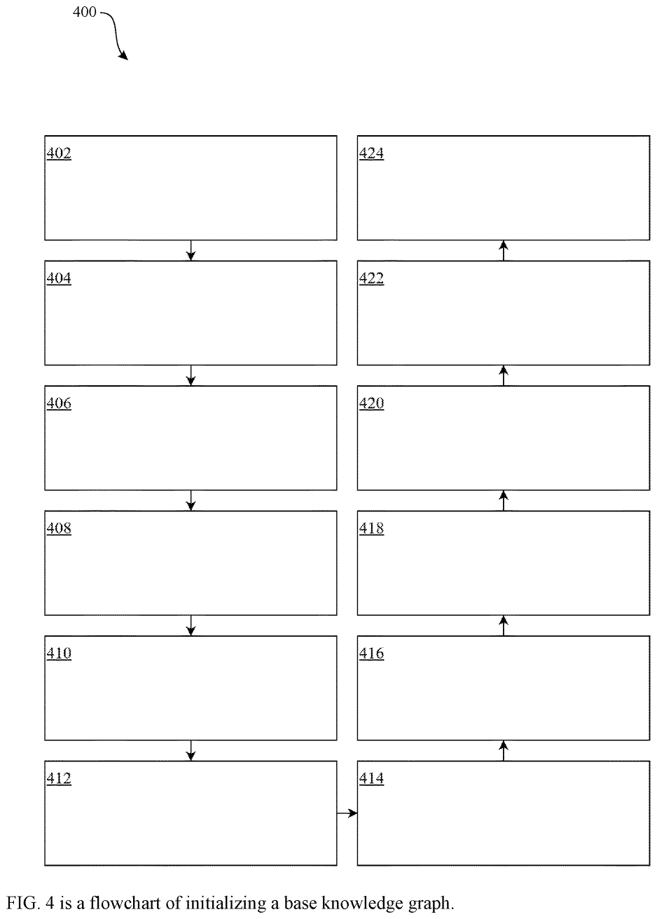

FIG. 4 shows a flow chart of an example method 400 for initializing and producing a versioned base knowledge graph, in accordance with embodiments of the disclosure. FIG. 4 is explained in conjunction with elements from FIG. 1 (e.g., system 106, data sources 108, and data stores 210A-210C). The steps from 402 to 424 may be implemented by any suitable computing system, such as the system 106 of FIG. 1.

Block 402 (Provision data stores). The system 106 provisions graph and auxiliary stores (e.g., 210A-210C), creating tables/collections for nodes, typed edges, attributes, embeddings, clustering artifacts, nearest-neighbor indices, and metrics. One embodiment materializes tables such as nodes, edges_* (including prerequisite and similarity edges), node_attrs, embeddings, edges_knn, and metrics.

Block 404 (Register sources). The system registers raw data sources 108 and any auxiliary corpora with adapters and schedules. Sources may include Q&A forums, documentation sites, educational repositories, code solutions, or API feeds. Each source is assigned ingestion parameters (format, cadence, retention) and provenance tags.

Block 406 (Ingest raw content). The system loads raw artifacts (e.g., posts, pages, comments, tags, votes, reactions, timestamps) and records source metadata (crawl time, content IDs, checksums). Content is stored in staging areas of 210C prior to normalization.

Block 408 (Normalize & canonicalize keywords). The system applies normalization rules to map noisy labels to canonical forms (e.g., lemmatization, case/diacritic folding, synonym resolution). Canonical forms and statistics are written to attribute tables (e.g., tag_canonical, tag_canonical_stats) for subsequent node building.

Block 410 (Build node catalog). The system materializes one node per canonical topic and attaches attributes (popularity, temporal signals, text summaries) in node_attrs. In some embodiments, nodes correspond to topics, sub-topics, or skills; in others, nodes may include content items that are later rolled up to topic nodes.

Base graph construction. Nodes are created from discovered content items; edges include at least prerequisite links authored or inferred by a classifier. The DoI d may be: (a) a curated curriculum level; (b) a topological order over the prerequisite subgraph; or (c) a regression-based difficulty score.

Block 412 (Compute node features). The system generates features used downstream, such as text/usage embeddings, acceptance/answer statistics, popularity time series, trend metrics, and other derived signals. Features are persisted for ranking and edge inference (e.g., in embeddings, tag_metrics).

Block 414 (Derive relationships-typed edges). The system computes multiple edge families: (i) co-occurrence and association (e.g., PMI/CPMI); (ii) embedding-based nearest neighbors; (iii) heuristic/policy-filtered edges; and (iv) optionally, prerequisite/part-of hints derived from features and curated rules. Raw scores and filtered edges are stored in edges_raw, edges_pmi, edges_knn, and edges_filtered within 210A.

Block 416 (Cluster & label regions). Community detection and tiering produce clusters/tiers of related topics. Human-readable labels (or automatically generated labels) are assigned and saved (e.g., cluster_labels) to support navigation and curriculum views.

Block 418 (Validate & prune). The system enforces schema and graph constraints, drops low-confidence edges, and ensures invariants (e.g., no self-loops in prerequisite edges; bounded out-degree). Failed records are quarantined with provenance for auditability.

Block 420 (Persist graph snapshot). The system writes a versioned, immutable snapshot of nodes, features, and typed edges to 210A, together with a build manifest and provenance, enabling reproducible downstream recommendation runs.

Block 422 (Build indexes & caches). The system constructs search/ANN/lookup indexes and traversal caches required for fast query-time operations by the recommender engine 208 (e.g., k-NN indices over embeddings and adjacency caches).

Block 424 (Expose interfaces). Read APIs are exposed via interfaces 206 to allow the recommender engine 208 and client services 212 to query nodes, edges, features, clusters, and snapshots. In some embodiments, the APIs support snapshot selection by version tag.

While FIG. 4 illustrates a Q&A-style corpus as a concrete example, other embodiments may apply the same pipeline to documentation sets, textbooks, MOOCs, research libraries, or mixed corpora. The pipeline is orthogonal to per-user processing (e.g., familiarity computation and region detection), which is described elsewhere herein.

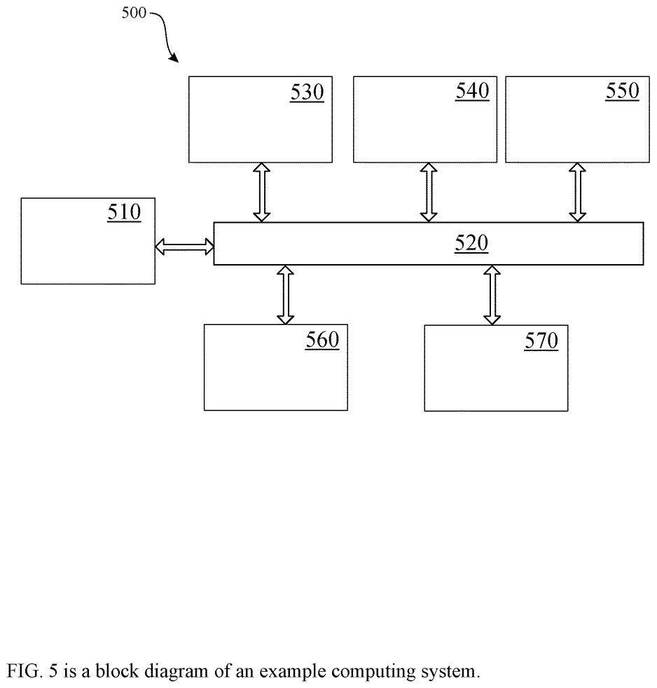

FIG. 5 illustrates an example computer system 500 in which or with which embodiments of the present disclosure may be implemented. In some embodiments, the system 106 of FIG. 1 may be implemented as the computer system 500. Alternatively, or additionally, the plurality of user devices 102 of FIG. 1 may also be implemented as the computer system 500.

As shown in FIG. 5, the computer system 500 may include an external storage device 510, a bus 520, a main memory 530, a read-only memory 540, a mass storage device 550, communication port(s) 560, and a processor 570. A person skilled in the art will appreciate that the computer system 500 may include more than one processor and communication ports. The processor 570 may include various modules associated with embodiments of the present disclosure. The communication port(s) 560 may be chosen depending on a network, such a Local Area Network (LAN), Wide Area Network (WAN), or any network to which the computer system 500 connects. The main memory 530 may be Random-Access Memory (RAM), or any other dynamic storage device commonly known in the art. The read-only memory 540 may be any static storage device(s) e.g., but not limited to, a Programmable Read Only Memory (PROM) chips for storing static information e.g., start-up or BIOS instructions for the processor 570. The mass storage device 550 may be any current or future mass storage solution, which can be used to store information and/or instructions.

The bus 520 communicatively couples the processor 570 with the other memory, storage, and communication blocks. Optionally, operator and administrative interfaces, e.g., a display, keyboard, joystick, and a cursor control device, may also be coupled to the bus 520 to support direct operator interaction with the computer system 500. Other operator and administrative interfaces can be provided through network connections connected through communication port(s) 560. The external storage device 510 may be any kind of external hard-drives, floppy drives, or the like. Components described above are meant only to exemplify various possibilities. In no way should the aforementioned exemplary computer system 500 limit the scope of the present disclosure.

The methods described herein may be performed using the systems described herein. In addition, it is contemplated that the methods described herein may be performed using systems different than the systems described herein. Moreover, the systems described herein may perform the methods described herein and may perform or execute instructions stored in a non-transitory computer-readable storage medium (CRSM). The CRSM may comprise any electronic, magnetic, optical, or other physical storage device that stores executable instructions. The instructions may comprise instructions to cause a processor to perform or control performance of operations of the proposed methods. It is also contemplated that the systems described herein may perform functions or execute instructions other than those described in relation to the methods and CRSMs described herein.

Furthermore, the CRSMs described herein may store instructions corresponding to the methods described herein, and may store instructions which may be performed or executed by the systems described herein. Furthermore, it is contemplated that the CRSMs described herein may store instructions different than those corresponding to the methods described herein, and may store instructions which may be performed by systems other than the systems described herein.

The methods, systems, and CRSMs described herein may include the features or perform the functions described herein in association with any one or more of the other methods, systems, and CRSMs described herein.

In some embodiments the method or methods described above may be executed or carried out by a computing system (for example, the computer system 500 of FIG. 5) including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the invention should be determined by the appended claims and their legal equivalents.

Multi-dimensional progression; Pareto frontiers. In some embodiments, the system defines multiple ordered dimensions of interest per node rather than a single scalar. For instance, a first dimension may encode prerequisite depth, a second dimension may encode estimated time cost, and a third dimension may encode relevance to one or more goal nodes. For a given user and request context, the system constructs a candidate set of nodes from one or more region bitsets, eligibility bitsets, or curriculum-field neighborhoods. The candidate set is represented as a candidate bitset CAND[u] over V. Dimension-specific score arrays are consulted to evaluate dominance relationships among candidates. Nodes that are dominated across all dimensions by some other candidate are cleared from CAND[u] using bitwise AND-NOT operations. After convergence, the remaining set bits in CAND[u] are copied into a frontier bitset FRONT[u] that compactly represents a Pareto-efficient frontier for that user and context. Recommendation modules may then select nodes exclusively from FRONT[u], optionally applying secondary ranking criteria within the frontier.

### Equation (7)—Frontier-Constrained Candidate Set.

In embodiments that combine frontier computation with gating constraints, a final selection candidate set for user u is derived from the intersection of a frontier bitset FRONT[u] and an eligibility bitset ELIG[u]. Let 1_{FRONT[u]}(n) and 1_{ELIG[u]}(n) denote the respective bit indicators. A node n is considered selectable if:

$$sel ( u , n ) = 1 \_ \{ FRONT [ u ] \} ( n ) \cdot 1 \_ \{ ELIG [ u ] \} ( n ) = 1 .$$

In one implementation, only nodes with sel(u, n)=1 are scored by a bandit-style selection score S(u, n) as in Equation (5); nodes with sel(u, n)=0 are ignored until their frontier or eligibility status changes.

Frontier-aware ranking and visualization. In some embodiments, nodes on the frontier bitset FRONT[u] are further divided into bands based on scalar projections of their multi-dimensional scores (for example, via a weighted sum of dimensions or a learned scoring model). The bands may be used to structure recommendation carousels or to color-code nodes in a visualization. The frontier bitset itself can be served 734 to a client user interface, enabling the client to highlight non-dominated nodes while de-emphasizing dominated alternatives. Because FRONT[u] is represented as a bitset, updates to the frontier in response to changes in the candidate set or in underlying dimension scores can be implemented via localized bit operations without scanning all nodes in the knowledge graph.

Diagnostic/information-gain mode. In some embodiments, the semantic progression layer operates in a diagnostic mode in which the primary objective is to reduce uncertainty about the user's state rather than to directly advance along a curriculum. In diagnostic mode, the system consults the diagnostic candidate bitset DIAG[u] and, for each node whose bit is set, computes an expected information gain value IG(u, n) based on the user's current mastery and uncertainty estimates and a model of possible assessment outcomes at that node. The expected information gain may be estimated by simulating or analytically integrating over discrete score outcomes and measuring the resulting reduction in a global uncertainty metric, such as the sum of entropies or variances across nodes of interest. The system selects one or more nodes with maximal IG(u, n) or with IG(u, n) above a specified percentile to present as diagnostic interactions to the user. Responses to these interactions update mastery and uncertainty estimates for the assessed nodes and for related prerequisite or successor nodes, thereby shrinking the space of plausible user states. Upon completion of a diagnostic burst, the system may switch back to a progression-oriented mode using updated mastery and familiarity signals.

Graph-constrained bandit and reinforcement-learning policies. In other embodiments, recommendation selection is driven by a contextual bandit or reinforcement-learning policy rather than a fixed ranking function. Each node or group of nodes is modelled as an arm with an associated reward estimate f (u, n). The eligibility bitset ELIG[u] is used to encode graph-constrained gating conditions so that arms corresponding to nodes with unset eligibility bits are not considered at selection time. For each node whose bit in ELIG[u] is set, a selection score S(u, n) is computed as a function of the reward estimate and an exploration bonus, such as an upper-confidence-bound, Thompson sampling score, or another exploration heuristic. The system selects a node with a maximal selection score among eligible nodes and surfaces it as a recommendation. After the user interacts with the recommended node, the system records a realized reward signal (e.g., mastery gain, dwell time, explicit rating) and updates the reward estimate and, where applicable, the parameters of the bandit or reinforcement-learning policy. In this manner, the system learns over time which regions of the graph produce better outcomes for the user while continuing to respect prerequisite and gating constraints encoded in ELIG[u].

Cohort-level overlays and assignments. In some embodiments, the semantic progression layer is instantiated at the level of a cohort of users, such as a classroom, organization unit, or study group. For each user in the cohort, user-specific region bitsets FWD[u], SKIP[u], and LAT[u] are maintained as described above. Cohort-level region bitsets, such as FWD_union[C] and SKIP_union[C], are computed by applying bitwise OR across the corresponding per-user bitsets for all u∈C, while FWD_intersect[C] and SKIP_intersect[C] are computed by applying bitwise AND across per-user bitsets. A cohort-level objective may prioritize, for example, reducing the size of SKIP_union[C] for a required curriculum, or maximizing the number of users whose familiar set covers nodes on FWD_union[C] before a deadline. Cohort-level assignments are generated by selecting node identifiers whose bits are set in one or more cohort-level region bitsets and whose inclusion improves the cohort-level objective, and by distributing those nodes to one or more cohort members as recommendations, tasks, or lessons.

Cohort progression dashboards and interventions. In some embodiments, a cohort-level dashboard visualizes the status of cohort-level bitsets over time, such as the fraction of cohort members who have cleared particular skipped nodes, or the distribution of mastery scores across nodes in FWD_union[C]. The system may suggest interventions to an instructor or administrator, such as adding a remedial session for nodes with high SKIP_union[C] density or splitting the cohort into sub-cohorts with different progression tracks based on their backbone coverage or frontier membership. Because cohort-level bitsets are derived from per-user bitsets via word-level bitwise operations, these visualizations and interventions can be updated incrementally as user-level events arrive.

Integration with curriculum-field and region-based embodiments. The multi-dimensional frontier, diagnostic, bandit, and cohort-level embodiments described herein are not limited to any single representation of progression. In some implementations, the frontier bitset FRONT[u] is computed over candidates drawn from the forward, skipped, and lateral regions. In other implementations, candidates are drawn from nodes whose curriculum-field values (u, n) exceed a threshold or from nodes reachable within a hop limit from a current vantage node. Similarly, the diagnostic candidate bitset DIAG[u] and eligibility bitset ELIG[u] may be populated from region membership, curriculum-field thresholds, mastery-gating criteria, or combinations thereof. Thus, the described mechanisms may be layered atop the FWD/SKIP/LAT region model, the mastery-gated model, or the curriculum-field model.

Implementation considerations. The bitsets and arrays described herein—including but not limited to region bitsets FWD/SKIP/LAT, the frontier bitset FRONT, the candidate bitset CAND, the diagnostic candidate bitset DIAG, the eligibility bitset ELIG, and cohort-level union and intersection bitsets—may be implemented as contiguous arrays of machine words, compressed bitmaps, or sharded bitset structures. Bitwise AND, OR, and AND-NOT operations are applied over blocks of machine words to implement set intersection, union, and subtraction. In one embodiment, dimension-specific score arrays, reward estimates, uncertainty estimates, and mastery scores are stored in columnar structures keyed by node identifier, enabling cache-friendly iteration aligned with bitset blocks. The specific storage layout and numerical representations are not limiting, and alternative implementations that maintain the functional relationships described herein are within the scope of the present disclosure.

Region-bitset store keyed by stable node identifiers. In some embodiments, each node in a versioned snapshot of the base knowledge graph is assigned a stable node identifier (e.g., an integer ID) that is stable within that snapshot and is used as the index space for one or more per-user bitsets described herein. In certain implementations, when the base knowledge graph is rebuilt or versioned into successive snapshots, the system maintains an identifier-mapping structure (e.g., alias table, remap table, or tombstone records) that maps node identifiers from a prior snapshot to corresponding node identifiers in a newer snapshot when a semantic correspondence exists (including merge, split, or replacement cases). A region-bitset record may be addressed by a composite key comprising (user identifier, region identifier, and a snapshot identifier and/or epoch identifier). The region-bitset store may be a key-value store, a memory-mapped file, a columnar store, or a distributed storage service; the particular storage mechanism is not limiting so long as it supports reading and updating bit positions for the node-identifier space of the applicable snapshot.

Snapshot alignment of progression constructs. In some embodiments, progression-related constructs stored for a user (including region bitsets, frontier bitsets, diagnostic bitsets, and eligibility bitsets) are tagged with the snapshot identifier against which they were computed. When a request references a different snapshot (or when the system advances a user to a newer snapshot), the system may (i) remap bit positions using the identifier-mapping structure, (ii) selectively recompute affected neighborhoods under the new snapshot, and/or (iii) rebuild one or more constructs from the user's underlying event history and the new snapshot. This snapshot tagging and alignment reduces ambiguity in audits and supports reproducible serving behavior.

Word-addressable mapping from node identifier to bit position. In one embodiment, each region bitset is stored as a contiguous array of fixed-width machine words. For an N-bit bitset represented by W-bit machine words (e.g., W=64), the bit position corresponding to node identifier i is located at word index [i/W] and bit offset (i mod W). Region membership queries are serviced by reading the corresponding machine word and testing the bit mask for the bit offset. This layout improves cache locality and supports block-wise bitwise set operations (e.g., AND, OR, AND-NOT) over contiguous machine-word ranges.

Persisted disjointness invariant and reconciliation procedure. In some embodiments, the system enforces and persists a disjointness invariant across the three region bitsets for each user: no node identifier is represented in more than one of FWD[u], SKIP[u], and LAT[u]. Disjointness is enforced by an exclusion precedence in which SKIP has priority over FWD, and the union of SKIP and FWD has priority over LAT. In a word-based bitset implementation, one non-limiting reconciliation procedure is applied block-by-block: (i) clear from FWD[u] any bits that are set in SKIP[u]; (ii) clear from LAT[u] any bits that are set in SKIP[u] or FWD[u]; and (iii) optionally clear from all three region bitsets any bits corresponding to node identifiers in the familiar set S_u (or in another exclusion set), thereby ensuring that region bitsets represent only non-familiar candidate nodes. Equivalent reconciliation procedures that ensure each node identifier appears in at most one region bitset are within the scope of the disclosure.

Deterministic region assignment under precedence. In some embodiments, when a node identifier meets criteria for multiple region categories (e.g., a node is both “lateral” by hop distance and “skipped” as an unmet prerequisite), the node identifier is deterministically assigned to exactly one region category according to the precedence order. This deterministic assignment provides stable behavior across repeated recomputations and supports reproducible audits of why a given node was surfaced to a user.

Trigger conditions for localized recomputation. In some embodiments, the delta-update engine initiates localized recomputation in response to one or more trigger conditions, including: (i) a node's familiarity score crossing a familiarity threshold τ in either direction; (ii) a change in a node's shortest-path parent pointer in the user backbone; (iii) addition, deletion, or reweighting of a prerequisite edge in the prerequisite subgraph; and/or (iv) a change in an active dimension-of-interest configuration (e.g., a difficulty scale update or a prerequisite-depth update). The delta-update engine records the trigger condition(s) and the affected node identifiers as update metadata.

Local-neighborhood computation. In some embodiments, the delta-update engine computes a local-neighborhood set N(u) of node identifiers around the affected node identifiers A(u) using one or more bounded graph traversals. By way of non-limiting example, N(u) may include: (i) nodes within a hop distance bound h from any affected node in the base knowledge graph; (ii) prerequisite ancestors of affected nodes up to a depth bound; (iii) prerequisite descendants (dependents) of affected nodes up to a depth bound; and/or (iv) nodes satisfying a lateral-tolerance test relative to one or more familiar nodes. The local-neighborhood set N(u) bounds the scope of recomputation and bounds the set of bit positions that may be set or cleared during delta maintenance.

Delta write format for setting and clearing bits. In some embodiments, updating region bitsets comprises writing one or more delta records that identify bit positions to set and bit positions to clear for a region bitset. A delta record may include: (i) a user identifier; (ii) a region identifier; (iii) a word index or partition identifier; (iv) a set-mask indicating bit positions to set within the addressed word or container; (v) a clear-mask indicating bit positions to clear within the addressed word or container; and (vi) a version tag (e.g., a prior epoch and/or new epoch) enabling idempotent application. When a delta record is applied, the region-bitset store updates the addressed portion of the bitset by setting bits indicated by the set-mask and clearing bits indicated by the clear-mask. In one embodiment, delta records are appended to a log prior to application (write-ahead logging) to support crash recovery and auditability.

Delta maintenance without full-graph scanning. In some embodiments, the delta-update engine computes updated membership only for node identifiers in the local-neighborhood set N(u), and generates deltas for those node identifiers by comparing (i) prior membership state and (ii) recomputed membership state for the neighborhood. The system thereby avoids recomputing region membership for all node identifiers of the knowledge graph in response to each user event.

Partitioned and compressed region bitsets. In some embodiments, the region-bitset store shards region bitsets by ranges of node identifiers (e.g., contiguous ID intervals) or by hash partitions of node identifiers. In such embodiments, the delta-update engine updates only those shards that contain node identifiers in the local-neighborhood set N(u). In some embodiments, one or more region bitsets are stored in a compressed bitset format comprising containers that represent sparse sets, dense sets, and/or ranges of node identifiers. Delta writes in a compressed format may be applied container-by-container, where each delta record identifies the container(s) impacted by the set-mask and clear-mask operations.

Atomicity and consistency across region bitsets. In some embodiments, the region-bitset store applies updates to FWD[u], SKIP[u], and LAT[u] in a manner that preserves the disjointness invariant across partial failures and concurrent updates. By way of non-limiting example, the store may: (i) apply updates under a per-user lock; (ii) apply updates using compare-and-swap on machine words together with a reconciliation pass; and/or (iii) apply updates as a transaction that commits a new epoch identifier for the trio of bitsets. Implementations may also record a snapshot identifier indicating the version of the base knowledge graph against which the bitsets were computed.

Rebuild and verification procedures. In some embodiments, the system periodically verifies or rebuilds per-user region bitsets to prevent drift, for example: (i) by recomputing regions from a consistent snapshot of the familiar set and prerequisite subgraph; (ii) by replaying the delta log for the user from a last-known-good checkpoint; and/or (iii) by sampling a subset of nodes and validating that bitset membership is consistent with the region definitions and precedence rules. These rebuild and verification procedures allow the system to maintain correctness while retaining the latency benefits of localized delta maintenance.

What is claimed is:

1. A computer-implemented method for generating a progression view over a graph-structured representation, the method performed by one or more processors and comprising:
(a) accessing a base knowledge graph comprising nodes and typed edges;
(b) selecting a dimension of interest defined over the nodes;
(c) selecting at least one anchor node in the base knowledge graph;
(d) computing, relative to the anchor node, one or more predicate-defined regions over candidate nodes, the one or more predicate-defined regions including at least one of:
(i) a forward region comprising nodes that are reachable from the anchor node by at least one ordered traversal comprising an ordered sequence of nodes connected by edges, the ordered traversal both (1) satisfying one or more traversal constraints and (2) satisfying an increasing condition on the dimension of interest relative to the anchor node; or
(ii) a backward region comprising nodes that are reachable from the anchor node by at least one ordered traversal comprising an ordered sequence of nodes connected by edges, the ordered traversal both (1) satisfying one or more traversal constraints and (2) satisfying a decreasing condition on the dimension of interest relative to the anchor node; and
(e) generating the progression view to include at least nodes belonging to at least one computed predicate-defined region.

2. The method of claim 1, wherein the increasing condition on the dimension of interest requires that, for at least one traversal from the anchor node to a candidate node that satisfies the one or more traversal constraints, values of the dimension of interest strictly increase from each successive node on the traversal to a next successive node on the traversal.

3. The method of claim 1, wherein the decreasing condition on the dimension of interest requires that, for at least one traversal from the anchor node to a candidate node that satisfies the one or more traversal constraints, values of the dimension of interest strictly decrease from each successive node on the traversal to a next successive node on the traversal.

4. The method of claim 1, wherein the one or more traversal constraints comprise at least one of: (i) a permitted edge-type family, (ii) a hop limit, (iii) a cost budget or score budget, (iv) an edge-threshold constraint, or (v) selection of a highest-scoring traversal or lowest-cost traversal among multiple candidate traversals.

5. The method of claim 1, further comprising computing a bounded neighborhood of the anchor node within a hop limit, wherein computing the one or more predicate-defined regions is restricted to candidate nodes in the bounded neighborhood.

6. The method of claim 1, wherein selecting the anchor node comprises selecting a current vantage node indicated by a user interface.

7. The method of claim 1, further comprising receiving a goal specification identifying one or more goal nodes in the base knowledge graph, and wherein the forward region, when computed, includes only nodes that satisfy the increasing condition on the dimension of interest and that additionally satisfy a goal-directed constraint requiring that at least one traversal exists from the anchor node to at least one of the goal nodes, the traversal (i) satisfying the one or more traversal constraints and (ii) satisfying the increasing condition on the dimension of interest.

8. The method of claim 7, wherein the goal specification is represented as a goal bitset over stable node identifiers that identifies the goal nodes, and wherein a node is eligible for inclusion in the forward region when there exists at least one goal node having a set bit in the goal bitset such that a traversal from the anchor node to the goal node (i) satisfies the one or more traversal constraints, (ii) satisfies the increasing condition on the dimension of interest, and (iii) includes the node.

9. The method of claim 1, wherein the backward region, when computed, comprises nodes for which there exists at least one traversal from the anchor node to the node that satisfies the one or more traversal constraints and the decreasing condition on the dimension of interest, and further comprises nodes that precede the anchor node along the selected dimension of interest, such nodes being prerequisite or preceding nodes relative to the anchor node.

10. The method of claim 1, wherein generating the progression view comprises omitting from a rendered view at least some nodes that satisfy none of the predicates defining the computed predicate-defined region or computed predicate-defined regions, or alternatively rendering such nodes with a neutral styling.

11. The method of claim 1, wherein the method computes exactly two predicate-defined regions consisting of the forward region and the backward region, and wherein the progression view includes nodes from both the forward region and the backward region.

12. The method of claim 1, further comprising operating in a forward-only mode in which the method computes the forward region and generates the progression view based on the forward region without computing the backward region.

13. The method of claim 1, further comprising operating in a backward-only mode in which the method computes the backward region and generates the progression view based on the backward region without computing the forward region.

14. The method of claim 1, wherein, when a node satisfies predicates of more than one computed region, the node is deterministically assigned to exactly one region according to a precedence rule.

15. The method of claim 1, wherein generating the progression view comprises generating a filtered subgraph that includes (i) nodes included in the progression view and (ii) edges incident to at least one included node.

16. The method of claim 1, wherein membership of at least one computed predicate-defined region is stored as a bitset over stable node identifiers, including: storing forward-region membership as a forward-region bitset when the forward region is computed, and storing backward-region membership as a backward-region bitset when the backward region is computed.

17. The method of claim 16, wherein the bitset is stored as a contiguous array of fixed-width machine words, and wherein a bit position corresponding to a stable node identifier is located at a word index equal to an integer quotient obtained by dividing the stable node identifier by a word width in bits, and at a bit offset equal to a remainder obtained by taking the stable node identifier modulo the word width in bits.

18. The method of claim 16, further comprising incrementally maintaining at least one of the forward-region bitset or the backward-region bitset via delta writes localized to a neighborhood affected by a change to at least one of: (i) the anchor node, (ii) a configuration of the dimension of interest, (iii) one or more edges of the base knowledge graph, or (iv) a user event that changes region membership for at least one node, wherein the incremental maintaining is performed without recomputing membership for all nodes of the base knowledge graph.

19. The method of claim 1, further comprising producing, for at least some nodes included in the progression view, a direction indicator relative to the anchor node, the direction indicator indicating whether a node is forward-directional or backward-directional, and further indicating a magnitude based on at least one of (i) a difference between a value of the dimension of interest at the node and a value of the dimension of interest at the anchor node or (ii) a path-based distance between the anchor node and the node.

20. The method of claim 1, wherein the method computes three or more predicate-defined regions by additionally computing at least one additional region defined by at least one additional predicate based on at least one of:
(i) hop distance from the anchor node;
(ii) a bounded tolerance on an absolute difference between a value of the dimension of interest at a node and a value of the dimension of interest at the anchor node; or
(iii) a band or interval of a difference between a value of the dimension of interest at a node and a value of the dimension of interest at the anchor node.
